(19) United States
(12) Patent Application Publication
(10) Pub. No.: US 2025/0034389 A1
(43) Pub. Date: Jan. 30, 2025

(54) Foam Body, Method for Producing Foam Body, and Laminate

(71) Applicant: ASAHI KASEI KABUSHIKI KAISHA, Tokyo (JP)

(72) Inventors: Yuya Sonoda, Tokyo (JP); Atsushi Nakagawa, Tokyo (JP)

(73) Assignee: ASAHI KASEI KABUSHIKI KAISHA, Tokyo (JP)

(21) Appl. No.: 18/782,483

(22) Filed: Jul. 24, 2024

(30) Foreign Application Priority Data
Jul. 25, 2023 (JP) 2023-120636
Jun. 7, 2024 (JP) 2024-092921

(51) Int. Cl. C08L 53/02; B29C 44/04; B29K 23/00; B29K 105/00; B32B 5/20; B32B 27/32; C08J 9/08; C08J 9/18

(52) U.S. Cl. CPC C08L 53/025; B32B 5/20; B32B 27/32; C08J 9/08; C08J 9/18; B29C 44/04; B29K 2023/12; B29K 2105/0094; B29K 2995/007; B32B 2266/025; B32B 2305/022; B32B 2307/536; B32B 2307/7376; C08J 2203/02; C08J 2353/02; C08J 2400/22; C08J 2423/12; C08L 2203/14; C08L 2205/03; C08L 2207/04; C08L 2207/53

(57) ABSTRACT

The present disclosure provides a foam body good in a molded appearance, a cushioning property, and wear resistance, and excellent also in property balance. The foam body is a foam body of a hydrogenated block copolymer composition containing a hydrogenated block copolymer (I), an olefin-based resin (II), a thermoplastic resin (III), and a softener (IV), and includes a foam core layer and a non-foam skin layer, the foam core layer has a thickness of 300 μm or more, the foaming ratio is 1.2-fold or more, a content of a polymer block (a) principally containing a vinyl aromatic monomer unit in the hydrogenated block copolymer (I) is 10 to 40% by mass, the hydrogenated block copolymer (I) contains a hydrogenated copolymer block (b) containing a vinyl aromatic monomer unit and a conjugated diene monomer unit.

### BACKGROUND OF THE INVENTION

### Field of the Invention

The present invention relates to a foam body, a method for producing a foam body, and a laminate.

### Description of the Related Art

In recent years, attentions are being paid, as a new direction of vehicles, to self-driving system and mobility service. Owing to this trend, performances required of vehicle components such as vehicle interior materials have been changed. For example, it is predicted that vehicles will have a stronger sense as a living space due to the self-driving system. Therefore, for creating a space where passengers can be comfortable, interiors have been increased in grades, and interior design has become highly diversified. As a result, resin compositions used as materials of vehicle interior materials are required to have a molded appearance capable of realizing a more intricate design, and foam body hardness capable of realizing a cushioning property with more comfortable feeling than a conventional composition.

From the viewpoint of the mobility service, in accordance with spread of car sharing, a long life and cleanliness of vehicles will be probably required. Therefore, the number of times of cleaning vehicle components such as vehicle interior materials will increase, and hence resin compounds used as the materials will need higher wear resistance.

Due to the spread of the self-driving system and the mobility service as described above, resin compositions need better molded appearance, better foam body hardness, and excellent wear resistance than those of conventional products.

As materials of vehicle components, a thermoplastic elastomer composition containing a hydrogenated product of a block copolymer consisting of a conjugated diene compound and a vinyl aromatic compound, an olefin-based resin, and a softener, and a foam molded article of the thermoplastic elastomer composition have been proposed (see, for example, Japanese Patent Laid-Open No. 2015-98542, Japanese Patent Laid-Open No. 2018-24822, and International Publication No. WO2016/039310).

A foam molded article of the thermoplastic elastomer composition conventionally proposed still has, however, a problem that there is a room for improvement from the viewpoint of balance among the molded appearance, the foam body hardness capable providing a comfortable cushioning property, and the wear resistance.

Therefore, an object of the present invention is to provide a foam body including a foam core layer and a non-foam skin layer, which is good in a molded appearance, a cushioning property, and wear resistance, and is also excellent in balance among these properties.

### SUMMARY OF THE INVENTION

The present inventors have made earnest studies to solve the problem of the conventional techniques described above, and as a result, have found the following: In a foam body of a hydrogenated block copolymer composition containing a hydrogenated block copolymer, an olefin-based resin, a thermoplastic resin, and a softener, the foam body including a foam core layer and a non-foam skin layer adjacent to each other, when the thickness of the foam core layer included in the foam body, the foaming ratio, the structure of the hydrogenated block copolymer, the hardness of the hydrogenated block copolymer composition, and the MFR of the hydrogenated block copolymer composition are specified respectively to fall in appropriate ranges, a foam body including a foam core layer and a non-foam skin layer, which is good in a molded appearance, a cushioning property, and wear resistance of the surface of the foam body, and is also excellent in balance among these properties, can be provided. Thus, the present invention has been accomplished.

Specifically, the present invention provides the following:

[1] A foam body of a hydrogenated block copolymer composition, containing:
a hydrogenated block copolymer (I);
an olefin-based resin (II);
a thermoplastic resin (III); and
a softener (IV),
wherein the foam body contains a foam core layer and a non-foam skin layer adjacent to each other,
the foam core layer has a thickness of 300 μm or more,
the foam body has a foaming ratio of 1.2-fold or more, and
the foam body satisfies the following conditions (1) to (5):
<Condition (1)>
the hydrogenated block copolymer (I) is a hydrogenated product of a block copolymer containing a vinyl aromatic monomer unit, and a conjugated monomer unit;
<Condition (2)>
the hydrogenated block copolymer (I) contains at least one polymer block (a) principally containing a vinyl aromatic monomer unit, and a content of the polymer block (a) principally containing a vinyl aromatic monomer unit in the hydrogenated block copolymer (I) is 10% by mass or more and 40% by mass or less;
<Condition (3)>
the hydrogenated block copolymer (I) contains at least one hydrogenated copolymer block (b) containing a vinyl aromatic monomer unit, and a conjugated diene monomer unit, and a content of the vinyl aromatic monomer unit in the hydrogenated copolymer block (b) is 5% by mass or more and 79% by mass or less;
<Condition (4)>
the hydrogenated block copolymer composition has a value of 15 seconds hardness measured with a type A durometer in accordance with JIS K6253 of 85 or less; and
<Condition (5)>
the hydrogenated block copolymer composition has an MFR value measured under conditions of a temperature of 230° C. and a load of 2.16 kg in accordance with JIS K7210 of 40 or more.

[2] The foam body according to [1], wherein a content of the vinyl aromatic monomer unit in the hydrogenated copolymer block (b) is 15% by mass or more and 79% by mass or less.

[3] The foam body according to [1] or [2], wherein the hydrogenated block copolymer (I) contains at least one polymer block (a) principally containing a vinyl aromatic monomer unit, and the content of the polymer block (a) principally containing a vinyl aromatic monomer unit in the hydrogenated block copolymer (I) is 15% by mass or more and 35% by mass or less.

[4] The foam body according to any one of [1] to [3], wherein the hydrogenated block copolymer composition has a value of 15 seconds hardness measured with a type A durometer in accordance with JIS K6253 of 30 or more and 75 or less.

[5] The foam body according to any one of [1] to [4], wherein the hydrogenated block copolymer composition has an MFR value measured under conditions of a temperature of 230° C. and a load of 2.16 kg in accordance with JIS K7210 of 100 or more and 1,000 or less.

[6] The foam body according to any one of [1] to [5], wherein the non-foam skin layer has a thickness of 10 μm to 500 μm.

[7] The foam body according to any one of [1] to [6], wherein the foam core layer has a thickness of 1,000 μm to 20,000 μm.

[8] The foam body according to any one of [1] to [7], wherein the olefin-based resin (II) comprises at least one polypropylene-based resin.

[9] The foam body according to any one of [1] to [8], wherein the foaming ratio is 1.5-fold or more.

[10] The foam body according to any one of [1] to [9], wherein the foam body is for use in a vehicle component selected from the group consisting of a side mall, a grommet, a shift knob, a weather strip, a window frame and a sealing material thereof, a dashboard, an assist grip, a steering wheel, a shift lever, a console, an arm rest, a head rest, and a door panel.

[11] A method for producing the foam body according to any one of [1] to [10], the method including:
a step of adding a foaming agent to the hydrogenated block copolymer composition, and injecting the resultant to fill a cavity, which is formed in a mold of an injection molding machine, and has a space volume adjustable with a movable core; and
a step of increasing the space volume of the cavity with the movable core to perform foam molding.

[12] A laminate including:
a layer containing the foam body according to any one of [1] to [10]; and
a layer containing a base resin.

[13] The laminate according to [12], wherein the layer containing the base resin and the layer containing the foam body are in direct contact with each other without an adhesive layer therebetween.

According to the present invention, a foam body including a foam core layer and a non-foam skin layer, which is good in a molded appearance, a cushioning property, and wear resistance, and is also excellent in balance among these properties, can be provided.

### BRIEF DESCRIPTION OF THE DRAWING

FIG. 1 is a cross-sectional view of a laminate of Example 37.

### DETAILED DESCRIPTION OF THE INVENTION

Now, an embodiment for practicing the present invention (hereinafter referred to as the “present embodiment”) will be described in detail. It is noted that the present embodiment described below is merely illustrative for describing the present invention and is not intended to limit the present invention, and that the present invention can be variously modified and changed within the scope thereof.

### [Foam Body]

A foam body of the present embodiment is a foam body of a hydrogenated block copolymer composition containing,
a hydrogenated block copolymer (I),
an olefin-based resin (II),
a thermoplastic resin (III), and
a softener (IV).

The foam body of the present embodiment includes a foam core layer, and a non-foam skin layer adjacent to each other, the foam core layer has a thickness of 300 μm or more, and the foam body has a foaming ratio of 1.2-fold or more, and satisfies the following conditions (1) to (5):
<Condition (1)>
the hydrogenated block copolymer (I) is a hydrogenated product of a block copolymer containing a vinyl aromatic monomer unit, and a conjugated monomer unit;
<Condition (2)>
the hydrogenated block copolymer (I) contains at least one polymer block (a) principally containing a vinyl aromatic monomer unit, and a content of the polymer block (a) principally containing a vinyl aromatic monomer unit in the hydrogenated block copolymer (I) is 10% by mass or more and 40% by mass or less;
<Condition (3)>
the hydrogenated block copolymer (I) contains at least one hydrogenated copolymer block (b) containing a vinyl aromatic monomer unit, and a conjugated diene monomer unit, and a content of the vinyl aromatic monomer unit in the hydrogenated copolymer block (b) is 5% by mass or more and 79% by mass or less;
<Condition (4)>
the hydrogenated block copolymer composition has a value of 15 seconds hardness measured with a type A durometer in accordance with JIS K6253 of 85 or less; and
<Condition (5)>
the hydrogenated block copolymer composition has an MFR value measured under conditions of a temperature of 230° C. and a load of 2.16 kg in accordance with JIS K7210 of 40 or more.

According to the above-described configuration, a foam body including a foam core layer and a non-foam skin layer, which is good in a molded appearance, a cushioning property, and wear resistance, and is also excellent in balance among these properties, can be obtained.

### (Hydrogenated Block Copolymer Composition)

The foam body of the present embodiment is a foam body of a hydrogenated block copolymer composition, and the hydrogenated block copolymer composition contains a hydrogenated block copolymer (I), an olefin-based resin (II), a thermoplastic resin (III), and a softener (IV).

### <Hydrogenated Block Copolymer (I)>

The hydrogenated block copolymer (I) used in the foam body of the present embodiment is a hydrogenated product of a block copolymer containing a vinyl aromatic monomer unit, and a conjugated diene monomer unit (Condition (1)).

### [Vinyl Aromatic Monomer Unit]

Examples of a vinyl aromatic compound forming the vinyl aromatic monomer unit include, but are not limited to, monomer units derived from styrene, α-methylstyrene, p-methylstyrene, divinyl benzene, 1,1-diphenyl ethylene, N,N-dimethyl-p-aminoethylstyrene, and N,N-diethyl-p-aminoethylstyrene.

In particular, from the viewpoint of balance between cost and mechanical strength of a hydrogenated block copolymer composition containing the hydrogenated block copolymer (I), styrene is preferred.

One of these monomer units may be singly used, or two or more of these may be used together.

### [Conjugated Diene Monomer Unit]

The conjugated diene monomer unit refers to a monomer unit derived from a diolefin having a pair of conjugated double bonds.

Examples of such a diolefin include, but are not limited to, 1,3-butadiene, 2-methyl-1,3-butadiene (isoprene), 2,3-dimethyl-1,3-butadiene, 1,3-pentadiene, 2-methyl-1,3-pentadiene, and 1,3-hexadiene.

In particular, from the viewpoint of balance between good molding processability and mechanical strength of the hydrogenated block copolymer composition, 1,3-butadiene and isoprene are preferred.

One of these may be singly used, or two or more of these may be used together.

Herein, the term “to principally contain” regarding the structure of a hydrogenated block copolymer means that the ratio in a prescribed block copolymer or a polymer block is 85% by mass or more, preferably 90% by mass or more, and more preferably 95% by mass or more.

It is noted that the content of the vinyl aromatic monomer unit in the hydrogenated copolymer block (b) is 5% by mass or more and 79% by mass or less (Condition (3)), and hence the polymer block (a) and the hydrogenated copolymer block (b) can be definitely distinguished from each other.

### [Polymer Block (a) Principally Containing Vinyl Aromatic Monomer Unit]

The hydrogenated block copolymer (I) used in the foam body of the present embodiment contains at least one polymer block (a) principally containing a vinyl aromatic monomer unit (Condition (2)). Thus, the blocking resistance of a pellet of the hydrogenated block copolymer (I) tends to be good.

In the hydrogenated block copolymer (I), the content of the polymer block (a) is 10% by mass or more, preferably 15% by mass or more, more preferably 20% by mass or more, and further preferably 25% by mass or more.

When the content of the polymer block (a) principally containing a vinyl aromatic monomer unit is 10% by mass or more, the blocking resistance of a pellet of the hydrogenated block copolymer (I) is good, and in addition, the foam body of the present embodiment exhibits excellent wear resistance and heat resistance.

When the blocking resistance of a pellet of the hydrogenated block copolymer (I) is good, blocking tends to be difficult to occur even in transportation for a longer time with a larger load, and in more severe temperature environment (as in, for example, a region with a high outside temperature, or a region with a wide range of temperature), and hence it can be expected that pellets are easily weighed and blended in molding a compound. Besides, since the amount of an anti-tack agent used in the hydrogenated block copolymer (I) can be reduced, it can be expected to avoid device pollution, reduce environmental load, and suppress unexpected degradation of physical properties, such as transparency, and mechanical strength.

When the foam body of the present embodiment exhibits good wear resistance, the composition can be used in a use as a vehicle material and the like that requires more severe wear resistance. For example, when it is used as a material, among vehicle interior materials and the like, of a thinner molded article, or a more complicated/larger molded article than a general molded article, and is used for a longer period of time, the appearance of the material can be expected to be retained comparably to the above-described general molded article. Besides, when the composition is used as a vehicle interior material, even if it is subjected to, at the time of a ride, friction with a larger load, or with a coarse fabric, such as a jeans fabric that is a fabric coarser than a cotton fabric of canequim #3, it can be expected that the appearance of the material can be retained for a long period of time.

In the hydrogenated block copolymer (I), the content of the polymer block (a) is 40% by mass or less, preferably 38% by mass or less, more preferably 36% by mass or less, and further preferably 35% by mass or less.

When the content, in the hydrogenated block copolymer (I), of the polymer block (a) principally containing a vinyl aromatic monomer unit is 40% by mass or less, the foam body of the present embodiment tends to exhibit good heat resistance, and when the content is 35% by mass or less, better heat resistance tends to be exhibited.

The content of the polymer block (a) in the hydrogenated block copolymer (I) can be measured by a method using a nuclear magnetic resonance apparatus (NMR) with the block copolymer before hydrogenation or the hydrogenated block copolymer used as a sample (a method described in Y. Tanaka, et al., RUBBER CHEMISTRY and TECHNOLOGY, 54, 685 (1981); hereinafter referred to as the “NMR method”).

The content of the polymer block (a) in the hydrogenated block copolymer (I) can be controlled to fall in the above-described numerical range by principally adjusting the amount of a vinyl aromatic compound to be added to a polymerization reactor, a reaction temperature and a reaction time.

[Hydrogenated Copolymer Block (b)]

The hydrogenated block copolymer (I) used in the foam body of the present embodiment contains at least one hydrogenated copolymer block (b) containing a vinyl aromatic monomer unit and a conjugated diene monomer unit (Condition (3)).

A content of the vinyl aromatic monomer unit in the hydrogenated copolymer block (b) is 5% by mass or more, preferably 15% by mass or more, more preferably 30% by mass or more, and further preferably 45% by mass or more.

When the content of the vinyl aromatic monomer unit in the hydrogenated copolymer block (b) is 5% by mass or more, the foam body of the present embodiment exhibits good wear resistance. Besides, when the content is 15% by mass or more, higher wear resistance is exhibited, and the composition can be used in a use requiring more severe wear resistance, for example, a use for forming a thinner molded article among vehicle interior materials, or a use requiring appearance retention for a longer period of time even if it is subjected to, at the time of a ride, friction with a larger load, or with a coarse fabric, such as a jeans fabric that is a fabric coarser than a cotton fabric of canequim #3 when used as the vehicle interior material.

The content of the vinyl aromatic monomer unit in the hydrogenated copolymer block (b) is 79% by mass or less, preferably 75% by mass or less, and more preferably 70% by mass or less.

When the content of the vinyl aromatic monomer unit in the hydrogenated copolymer block (b) is 79% by mass or less, the foam body of the present embodiment exhibits good heat resistance, and can be used in a use requiring severe heat resistance, for example, a use for forming a thinner molded article among vehicle interior materials, or a use requiring resistance for realizing retention of sense of touch (leather-texture touch) and shape retention (resistance against deformation by heat) for a longer period of time even when used for a long period of time, or used at a higher temperature.

It is noted that the content of the vinyl aromatic monomer unit in the hydrogenated copolymer block (b) can be measured using a nuclear magnetic resonance apparatus (NMR) or the like.

The content of the vinyl aromatic monomer unit in the hydrogenated copolymer block (b) can be controlled to fall in the above-described numerical range by adjusting the amounts of a vinyl aromatic compound and a conjugated diene to be added to a polymerization reactor, a reaction temperature and the like.

### [Hydrogenated Polymer Block (c) Principally Containing Conjugated Diene Monomer Unit]

The hydrogenated block copolymer (I) used in the foam body of the present embodiment may contain at least one hydrogenated polymer block (c) principally containing a conjugated diene monomer unit (hereinafter, sometimes referred to as the hydrogenated polymer block (c)).

When the hydrogenated block copolymer (I) contains the hydrogenated polymer block (c), the foam body of the present embodiment tends to exhibit good wear resistance, scratch resistance, and low temperature property. When the hydrogenated block copolymer (I) contains the hydrogenated polymer block (c), there is a tendency, in the foam body of the present embodiment, that the compatibility of the hydrogenated block copolymer (I) with the polyolefin-based resin (II) or the thermoplastic resin (III) described below is improved, that the interface strength is improved, and that the wear resistance, the scratch resistance, and the low temperature property are improved.

### [Weight Average Molecular Weight of Hydrogenated Block Copolymer (I)]

A weight average molecular weight (Mw) of the hydrogenated block copolymer (I) used in the foam body of the present embodiment is, from the viewpoints of obtaining extrusion moldability in producing pellets of the hydrogenated block copolymer (I), and good mechanical strength of the foam body of the present embodiment, preferably 20,000 or more, more preferably 30,000 or more, and further preferably 50,000 or more.

The upper limit of the weight average molecular weight (Mw) is preferably 300,000 or less, more preferably 200,000 or less, and further preferably 150,000 or less. When the weight average molecular weight (Mw) is 300,000 or less, the hydrogenated block copolymer (I) is easily melted at the time of producing (at the time of extrusion molding) pellets of the hydrogenated block copolymer (I), and hence strands are stabilized, which tends to improve extrusion moldability.

It is noted that the weight average molecular weight of the hydrogenated block copolymer (I) of the present embodiment is obtained by performing gel permeation chromatography (GPC) measurement, and using a calibration curve obtained through measurement of commercially available standard polystyrene (created by using a peak molecular weight of the standard polystyrene).

### [Molecular Weight Distribution (Mw/Mn) of Hydrogenated Block Copolymer (I)]

A molecular weight distribution (Mw/Mn) of the hydrogenated block copolymer (I) used in the foam body of the present embodiment is not especially limited, and is preferably 10 or less, more preferably 3 or less, and further preferably 1.5 or less from the viewpoint of molding processability of the hydrogenated block copolymer (I). The lower limit of the Mw/Mn is preferably 1 or more, more preferably 1.005 or more, and further preferably 1.01 or more from the viewpoint of the molding processability of the hydrogenated block copolymer (I).

The weight average molecular weight (Mw) and a number average molecular weight (Mn) of the hydrogenated block copolymer (I) are obtained by performing gel permeation chromatography (GPC) measurement, and obtaining a peak molecular weight in the resultant chromatogram using a calibration curve obtained through measurement of commercially available standard polystyrene (created by using a peak molecular weight of the standard polystyrene). The molecular weight distribution (Mw/Mn) of the hydrogenated block copolymer (I) is obtained based on a ratio between the weight average molecular weight (Mw) and the number average molecular weight (Mn).

### [Hydrogenation Rate of Double Bond of Conjugated Diene Monomer Unit in Hydrogenated Block Copolymer (I)]

The hydrogenation rate of a double bond of the conjugated diene monomer unit in the hydrogenated block copolymer (I) used in the foam body of the present embodiment is preferably 20% or more, more preferably 50% or more, and further preferably 92% or more from the viewpoint of obtaining good weather resistance.

In particular, since high wear resistance and weather resistance are required in a use as a vehicle interior material, the hydrogenation rate tends to be preferably 92% or more.

The hydrogenation rate of a double bond of the conjugated diene monomer unit in the hydrogenated block copolymer (I) can be controlled to fall in the above-described numerical range by adjusting a hydrogenation amount. The hydrogenation rate can be measured with a nuclear magnetic resonance apparatus (NMR) or the like.

### [Structure of Hydrogenated Block Copolymer (I)]

The hydrogenated block copolymer (I) used in the foam body of the present embodiment is not especially limited, and examples include structures represented by the following general formulas.

a-b-a, (a-b)ₙ-X, c-(b-a)ₙ, c-(a-b)ₙ, c-(a-b-a)ₙ, c-(b-a-b)ₙ, c-(b-c-a)ₙ, a-(c-b-c-a)ₙ, a-c-(b-a)ₙ, a-c-(a-b)ₙ, a-c-(b-a)ₙ-b, c-a-(b-a)ₙ-c, a-c-(b-a)ₙ-C, a-b-(c-a)ₙ-b, a-c-(b-c)ₙ-a-c, c-(a-b-c)ₙ-a-c, a-(c-b)ₙ-c-a, c-(a-c)ₙ-b-c-a-c, [(a-b-c)ₙ]ₘ-X, [a-(b-c)ₙ]ₘ-X, [(a-b)ₙ-c]ₘ-X, [(a-b-a)ₙ-c]ₘ-X, [(b-a-b)ₙ-c]ₘ-X, [(c-b-a)ₙ]ₘ-X, [c-(b-a)ₙ]ₘ-X, [c-(a-b-a)ₙ]ₘ-X, and [c-(b-a-b)ₙ]ₘ-X.

In these general formulas, a represents the polymer block (a) principally containing a vinyl aromatic monomer unit, b represents the hydrogenated copolymer block (b) containing a vinyl aromatic monomer unit and a conjugated diene monomer unit, and c represents the hydrogenated polymer block (c) principally containing a conjugated diene monomer unit.

Also in these general formulas, n represents an integer of 1 or more, and is preferably an integer of 1 to 5; m represents an integer of 2 or more, and is preferably an integer of 2 to 11; and X represents a residue of a coupling agent or a residue of a multifunctional initiator.

The hydrogenated block copolymer (I) used in the foam body of the present embodiment may be a modified block copolymer in which atomic groups each having a prescribed functional group are bonded to one another. Since the influence of the presence of a functional group on the hardness and/or MFR of the hydrogenated block copolymer (I) is small, whether or not the hydrogenated block copolymer (I) is modified, which type of a functional group is used, and the like may be appropriately set in accordance with structures and the like of resins to be kneaded with the hydrogenated block copolymer (I).

When the hydrogenated block copolymer (I) is a modified block copolymer, it may be a secondary modified block copolymer. Herein, “secondary modification” is a name characterized by a production method, and a first process of bonding a functional group to a block copolymer is referred to as primary modification, and a process of reacting the functional group with another compound is referred to as secondary modification. For example, in a typical production method of a secondary modified block copolymer, a secondary modified product is produced by reacting, with another compound (such as maleic acid) in an extruder, a primary modified product obtained by a reaction of a denaturant (such as amine) with a polymerization completion end after polymerization in a solution.

### <Production Method for Hydrogenated Block Copolymer (I)>

A block copolymer corresponding to a state obtained before the hydrogenation of the hydrogenated block copolymer (I) used in the foam body of the present embodiment is obtained, for example, by living anionic polymerization of a vinyl aromatic compound and a conjugated diene compound performed in a hydrocarbon solvent by using a polymerization initiator such as an organic alkali metal compound.

### [Hydrocarbon Solvent]

Examples of the hydrocarbon solvent include, but are not limited to, aliphatic hydrocarbons such as n-butane, isobutane, n-pentane, n-hexane, n-heptane and n-octane; alicyclic hydrocarbons such as cyclohexane, cycloheptane and methylcycloheptane; and aromatic hydrocarbons such as benzene, toluene, xylene and ethylbenzene.

### [Polymerization Initiator]

The polymerization initiator is not especially limited, and examples include organic alkali metal compounds such as an aliphatic hydrocarbon alkali metal compound, an aromatic hydrocarbon alkali metal compound and an organic amino alkali metal compound, which are known to have anionic polymerization activity on a vinyl aromatic compound and a conjugated diene.

Preferable examples of the organic alkali metal compounds include, but are not limited to, aliphatic and aromatic hydrocarbon lithium compounds having 1 to 20 carbon atoms, and a compound containing one lithium in one molecule, and a dilithium compound, a trilithium compound and a tetralithium compound each containing a plurality of lithiums in one molecule can be applied.

Specific examples include n-propyllithium, n-butyllithium, sec-butyllithium, tert-butyllithium, n-pentyllithium, n-hexyllithium, benzyllithium, phenyllithium, trityllithium, a reaction product of diisopropylbenzene and sec-butyllithium, and a reaction product of divinylbenzene, sec-butyllithium and a small amount of 1,3-butadiene.

In addition, organic alkali metal compounds disclosed in, for example, U.S. Pat. No. 5,708,092, British Patent No. 2,241,239, and U.S. Pat. No. 5,527,753 can be applied.

### [Modifier]

When a vinyl aromatic compound and a conjugated diene are copolymerized by using an organic alkali metal compound as a polymerization initiator, a content of vinyl bonds (such as 1,2-bond or 3,4-bond) derived from the conjugated diene incorporated into a resultant polymer, and random copolymerizability between the vinyl aromatic compound and the conjugated diene can be adjusted by using a prescribed modifier.

Examples of such a modifier include, but are not limited to, a tertiary amine compound, an ether compound, and a metal alcoholate compound.

One of these modifiers may be singly used, or two or more of these may be used in combination.

An example of the tertiary amine compound includes, but is not limited to, a compound represented by a general formula R1R2R3N (wherein R1, R2 and R3 represent a hydrocarbon group having 1 to 20 carbon atoms, or a hydrocarbon group having a tertiary amino group).

Specific examples include trimethylamine, triethylamine, tributylamine, N,N-dimethylaniline, N-ethylpiperidine, N-methylpyrrolidine, N,N,N′,N′-tetramethylethylenediamine, N,N,N′,N′-tetraethylethylenediamine, 1,2-dipiperidinoethane, trimethylaminoethylpiperazine, N,N,N′,N″,N″-pentamethylethylenetriamine, and N,N′-dioctyl-p-phenylenediamine.

Examples of the ether compound include, but are not limited to, a linear ether compound and a cyclic ether compound.

Examples of the linear ether compound include, but are not limited to, dialkyl ether compounds of ethylene glycol, such as dimethyl ether, diethyl ether, diphenyl ether, ethylene glycol dimethyl ether, ethylene glycol diethyl ether, and ethylene glycol dibutyl ether; and dialkyl ether compounds of diethylene glycol, such as diethylene glycol dimethyl ether, diethylene glycol diethyl ether, and diethylene glycol dibutyl ether.

Examples of the cyclic ether compound include, but are not limited to, alkyl ethers such as tetrahydrofuran, dioxane, 2,5-dimethyloxolane, 2,2,5,5-tetramethyloxolane, 2,2-bis(2-oxolanyl)propane, and furfuryl alcohol.

Examples of the metal alcoholate compound include, but are not limited to, sodium-t-pentoxide, sodium-t-butoxide, potassium-t-pentoxide, and potassium-t-butoxide.

### [Polymerization Method]

As a method for polymerizing a vinyl aromatic compound and a conjugated diene by using an organic alkali metal compound as a polymerization initiator, a conventionally known method can be applied.

For example, the polymerization method may be, but is not limited to, any one of batch polymerization, continuous polymerization and a combination of these methods. In particular, for obtaining a block copolymer excellent in heat resistance, batch polymerization is suitably employed.

A polymerization temperature is preferably 0° C. to 180° C., and more preferably 30° C. to 150° C. A polymerization time is varied depending on conditions, and is usually 48 hours or less, and preferably 0.1 to 10 hours.

As an atmosphere of a polymerization system, an inert gas atmosphere such as nitrogen gas is preferred.

A polymerization pressure is not especially limited as long as it is set within a pressure range where monomers and a solvent can be retained in a liquid phase in the above-described temperature range.

Attention is preferably paid so that an impurity inactivating a catalyst and a living polymer, such as water, oxygen and carbon dioxide, cannot enter the polymerization system.

In completing the polymerization process, a coupling reaction may be performed with a necessary amount of a bi- or higher functional coupling agent added thereto.

As a bifunctional coupling agent, any of known agents can be used, and examples include, but are not limited to, alkoxysilane compounds such as trimethoxysilane, triethoxysilane, tetramethoxysilane, tetraethoxysilane, dimethyldimethoxysilane, diethyldimethoxysilane, dichlorodimethoxysilane, dichlorodiethoxysilane, trichloromethoxysilane and trichloroethoxysilane; dihalogen compounds such as dichloroethane, dibromoethane, dimethyldichlorosilane and dimethyldibromosilane; and acid esters such as methyl benzoate, ethyl benzoate, phenyl benzoate, and phthalic acid esters.

A tri- or higher functional coupling agent is not especially limited, and any of conventionally known agents can be used, and examples include tri- or higher valent polyalcohols, polyvalent epoxy compounds such as epoxidized soybean oil, diglycidyl bisphenol A, and 1,3-bis(N—N′-diglycidylaminomethyl)cyclohexane; a silicon halide compound represented by a general formula R₄-nSiXₙ (wherein R represents a hydrocarbon group having 1 to 20 carbon atoms, X represents a halogen, and n represents an integer of 3 to 4), such as methyl silyl trichloride, t-butyl silyl trichloride, silicon tetrachloride, and a bromide of any of these; and a tin halide compound represented by a general formula R₄-nSnXₙ (wherein R represents a hydrocarbon group having 1 to 20 carbon atoms, X represents a halogen, and n represents an integer of 3 to 4), such as methyl tin trichloride, t-butyl tin trichloride, and tin tetrachloride. Alternatively, dimethyl carbonate, diethyl carbonate or the like may be used.

### [Modification Process]

The hydrogenated block copolymer (I) used in the foam body of the present embodiment may be a modified block copolymer in which atomic groups each having a functional group are bonded to one another. The atomic groups having a functional group are bonded preferably in process preceding hydrogenation process described later.

An example of the “atomic group having a functional group” includes, but is not limited to, an atomic group having at least one functional group selected from the group consisting of a hydroxyl group, a carboxyl group, a carbonyl group, a thiocarbonyl group, an acid halide group, an acid anhydride group, a carboxylic acid group, a thiocarboxylic acid group, an aldehyde group, a thioaldehyde group, a carboxylic ester group, an amide group, a sulfonic acid group, a sulfonic ester group, a phosphoric acid group, a phosphoric ester group, an amino group, an imino group, a nitrile group, a pyridyl group, a quinoline group, an epoxy group, a thioepoxy group, a sulfide group, an isocyanate group, an isothiocyanate group, a silicon halide group, a silanol group, an alkoxysilicone group, a tin halide group, a boronic acid group, a boron-containing group, a boronate group, an alkoxytin group, and a phenyltin group. In particular, an atomic group having at least one functional group selected from the group consisting of a hydroxyl group, an epoxy group, an amino group, a silanol group, and an alkoxysilane group is preferred.

The “atomic group having a functional group” can be bonded with a denaturant.

Examples of the denaturant include, but are not limited to, tetraglycidyl methaxylene diamine, tetraglycidyl-1,3-bisaminomethylcyclohexane, Σ-caprolactone, δ-valerolactone, 4-methoxybenzophenone, γ-glycidoxyethyltrimethoxysilane, γ-glycidoxypropyltrimethoxysilane, γ-glycidoxypropyldimethylphenoxysilane, bis(γ-glycidoxypropyl)methylpropoxysilane, 1,3-dimethyl-2-imidazolidine, 1,3-diethyl-2-imidazolidinone, N,N′-dimethylpropyleneurea, and N-methylpyrrolidone.

Although not especially limited, the modified block copolymer can be obtained, for example, by anionic living polymerization for performing polymerization using a polymerization initiator having a functional group or an unsaturated monomer having a functional group, for forming a functional group at a living end, or for performing an addition reaction with a denaturant having a functional group.

As another method for obtaining the modified block copolymer, a method in which a block copolymer is reacted (metalation reaction) with an organic alkali metal compound such as an organic lithium compound, and the thus obtained block polymer to which the organic alkali metal has been added is addition reacted with a denaturant having a functional group to obtain the modified block copolymer can be employed.

In employing the latter method, however, the metalation reaction can be performed after obtaining the hydrogenated block copolymer and then the resultant can be reacted with a denaturant to produce a modified hydrogenated block copolymer.

A temperature for performing a modification reaction is preferably 0° C. to 150° C., and more preferably 20° C. to 120° C. A time necessary for the modification reaction is varied depending on the other conditions, and is preferably 24 hours or less, and more preferably 0.1 to 10 hours.

Depending on the type of a denaturant used, an amino group or the like has been sometimes generally changed into an organic metal salt when the denaturant is reacted, and in such a case, the organic metal salt can be converted into an amino group or the like through a treatment with water or a compound having active hydrogen such as alcohol. It is noted that such a modified block copolymer may partially contain a non-modified block copolymer.

The modified block copolymer may be a secondary modified block copolymer. A secondary modified block copolymer can be obtained by reacting a modified block copolymer with a secondary denaturant reactive with a functional group of the modified block copolymer.

The secondary denaturant is not especially limited, and an example includes a denaturant having a functional group selected from the group consisting of a carboxyl group, an acid anhydride group, an isocyanate group, an epoxy group, a silanol group, and an alkoxysilane group, and the secondary denaturant has at least two functional groups selected from these functional groups. When the functional group is an acid anhydride group, however, the secondary denaturant may have merely one acid anhydride group.

When the modified block copolymer is reacted with the secondary denaturant as described above, the amount of the secondary denaturant used per equivalent of a functional group bonded to the modified block copolymer is preferably 0.3 moles to 10 moles, more preferably 0.4 moles to 5 moles, and further preferably 0.5 moles to 4 moles.

A method for reacting the modified block copolymer with the secondary denaturant is not especially limited, and any of known methods can be applied. Examples of the method include a melt kneading method described later, and a method in which respective components are dissolved or dispersed in a solvent or the like to be mixed for the reaction. It is noted that such secondary modification is performed preferably after the hydrogenation process of the block copolymer.

Preferable examples of the secondary denaturant include, but are not limited to, maleic anhydride, pyromellitic anhydride, 1,2,4,5-benzenetetracarboxylic dianhydride, toluylene diisocyanate, tetraglycidyl-1,3-bisaminomethylcyclohexane, and bis-(3-triethoxysilylpropyl)-tetrasulfane.

The hydrogenated block copolymer (I) used in the foam body of the present embodiment can be a modified block copolymer graft modified with α,β-unsaturated carboxylic acid or a derivative thereof, such as an anhydride, an esterified product, an amidated product, or an imidated product thereof.

Examples of the α,β-unsaturated carboxylic acid or a derivative thereof include, but are not limited to, maleic anhydride, maleic anhydride imide, acrylic acid or an ester thereof, methacrylic acid or an ester thereof, and endo-cis-bicyclo[2,2,1]-5-heptene-2,3-dicarboxylic acid or an anhydride thereof.

The amount of the α,β-unsaturated carboxylic acid or a derivative thereof to be added is, with respect to 100 parts by mass of the hydrogenated block copolymer before modification, preferably 0.01 to 20 parts by mass, and more preferably 0.1 to 10 parts by mass.

A reaction temperature in the graft modification is preferably 100° C. to 300° C., and more preferably 120° C. to 280° C.

A method for the graft modification is not especially limited, and for example, a method described in Japanese Patent Laid-Open No. 62-79211 can be applied.

### [Hydrogenation Reaction Process]

The hydrogenated block copolymer (I) used in the foam body of the present embodiment can be obtained by subjecting the above-described non-hydrogenated non-modified or modified block copolymer to a hydrogenation reaction using a prescribed hydrogenation catalyst.

Examples of the hydrogenation catalyst include, but are not limited to, known catalysts of (1) a supported heterogenous hydrogenation catalyst in which a metal such as Ni, Pt, Pd, or Ru is supported on carbon, silica, alumina, diatomaceous earth or the like, (2) what is called a Ziegler hydrogenation catalyst using an organic acid salt of Ni, Co, Fe, Cr or the like or a transition metal salt such as an acetylacetone salt, and a reducing agent such as organic aluminum, and (3) a homogenous hydrogenation catalyst such as what is called an organic metal complex of an organic metal compound or the like of Ti, Ru, Rh, Zr or the like.

Alternatively, as the hydrogenation catalyst, hydrogenation catalysts not limited to but such as those described in Japanese Patent Publication Nos. 42-8704, 43-6636, 63-4841, 1-37970, 1-53851 and 2-9041 can be used.

Suitable examples of the hydrogenation catalyst include a titanocene compound, a reducing organometallic compound, and a mixture of these.

The titanocene compound is not especially limited, and for example, a compound described in Japanese Patent Laid-Open Publication No. 8-109219 can be used. A specific example includes a compound having at least one ligand having a (substituted) cyclopentadienyl skeleton, an indenyl skeleton or a fluorenyl skeleton, such as bis-cyclopentadienyl titanium dichloride or mono-pentamethylcyclopentadienyl titanium trichloride.

Examples of the reducing organometallic compound include, but are not limited to, an organic alkali metal compound such as organic lithium, an organic magnesium compound, an organic aluminum compound, an organic boron compound, and an organic zinc compound.

The hydrogenation reaction will now be described.

A reaction temperature is generally preferably a temperature range of 0° C. to 200° C., and more preferably a temperature range of 30° C. to 150° C.

A pressure of hydrogen used in the hydrogenation reaction is preferably 0.1 MPa to 15 MPa, more preferably 0.2 MPa to 10 MPa, and further preferably 0.3 MPa to 5 MPa.

A hydrogenation reaction time is usually preferably 3 minutes to 10 hours, and more preferably 10 minutes to 5 hours.

The hydrogenation reaction may be performed by any of batch process, continuous process, and a combination of these.

It is preferable that a catalyst residue is removed, if necessary, from a solution of a hydrogenated block copolymer resulting from the hydrogenation reaction, and that the hydrogenated block copolymer is separated from the solution.

Examples of a separation method include, but are not limited to, a method in which a polar solvent working as a poor solvent for a hydrogenated modified copolymer, such as acetone or alcohol, is added to a reaction solution after the hydrogenation to precipitate and collect the polymer: a method in which the reaction solution is put in hot water under stirring, and the solvent is removed by steam stripping to collect the polymer; and a method in which the polymer solution is directly heated to remove the solvent.

It is noted that a stabilizer, such as various phenol-based stabilizers, phosphorus-based stabilizers, sulfur-based stabilizers and amine-based stabilizer, may be added to the hydrogenated block copolymer (I) used in the foam body of the present embodiment.

### <Olefin-Based Resin (II)>

The hydrogenated block copolymer composition contained in the foam body of the present embodiment contains the olefin-based resin (II).

Examples of the olefin-based resin (II) used in the foam body of the present embodiment include, but are not limited to, homopolymers of α-olefins such as polyethylene (PE), polypropylene (PP), 1-butene, 1-pentene, 1-hexene, 3-methyl-1-butene, 4-methyl-1-pentene, and 1-octene. Other examples include a random copolymer or a block copolymer containing a combination of olefins selected from the group consisting of ethylene, propylene, butene, pentene, hexene and octene.

Specific examples include ethylene and/or propylene-α-olefin copolymers such as an ethylene-propylene copolymer, an ethylene-1-butene copolymer, an ethylene-3-methyl-1-butene copolymer, an ethylene-4-methyl-1-pentene copolymer, an ethylene-1-hexene copolymer, an ethylene-1-octene copolymer, an ethylene-1-decene copolymer, a propylene-1-butene copolymer, a propylene-1-hexene copolymer, a propylene-1-octene copolymer, a propylene-4-methyl-1-pentene copolymer, an ethylene-propylene-1-butene copolymer, a propylene-1-hexene-ethylene copolymer, and a propylene-1-octene-ethylene copolymer.

A copolymer of ethylene and/or propylene encompasses a copolymer with another unsaturated monomer excluding the α-olefin.

Examples of the copolymer with another unsaturated monomer include, but are not limited to, copolymers of ethylene and/or propylene with unsaturated organic acids or derivatives thereof, such as acrylic acid, methacrylic acid, maleic acid, itaconic acid, methyl acrylate, methyl methacrylate, maleic anhydride, aryl maleimide, and alkyl maleimide: copolymers of ethylene and/or propylene with vinyl esters such as vinyl acetate; and copolymers of ethylene and/or propylene with non-conjugated dienes such as dicyclopentadiene, 4-ethylidene-2-norbornene, 4-methyl-1,4-hexadiene, and 5-methyl-1,4-hexadiene.

The olefin-based resin (II) preferably contains at least one polypropylene-based resin from the viewpoint of obtaining economic efficiency, and good compatibility with another component contained in the hydrogenated block copolymer composition contained in the foam body of the present embodiment to attain high transparency.

The olefin-based resin (II) may be modified with a prescribed functional group.

The functional group is not especially limited, and examples include an epoxy group, a carboxy group, an acid anhydride group, and a hydroxyl group.

A functional group-containing compound or a denaturant to be used for modifying the olefin-based resin (II) is not especially limited, and includes the following compounds:

Unsaturated epoxides such as glycidyl methacrylate, glycidyl acrylate, vinyl glycidyl ether, and allyl glycidyl ether; and unsaturated organic acids such as maleic acid, fumaric acid, itaconic acid, citraconic acid, allyl succinic acid, maleic anhydride, fumaric anhydride, and itaconic anhydride. Other unlimited examples include an ionomer and chlorinated polyolefin.

From the viewpoints of obtaining economic efficiency and good compatibility in the hydrogenated block copolymer composition contained in the foam body of the present embodiment to attain high transparency, the olefin-based resin (II) is preferably a polypropylene-based resin such as a polypropylene homopolymer or an ethylene-propylene random or block copolymer.

In particular, from the viewpoint of the transparency and flexibility, the olefin-based resin (II) is more preferably an ethylene-propylene random copolymer.

The olefin-based resin (II) may contain a single material, or may contain two or more materials.

### <Thermoplastic Resin (III)>

The hydrogenated block copolymer composition contained in the foam body of the present embodiment contains the thermoplastic resin (III).

Examples of the thermoplastic resin (III) include, but are not limited to, a block copolymer of a conjugated diene compound and a vinyl aromatic compound or a hydrogenated product thereof (which is, however, different from the hydrogenated block copolymer (I) of the present embodiment), polymers of the vinyl aromatic compound, copolymer resins of the vinyl aromatic compound and another vinyl monomer, such as ethylene, propylene, butylene, vinyl chloride, vinylidene chloride, vinyl acetate, acrylic acid, and acrylic acid ester such as methyl acrylate, methacrylic acid and methacrylic acid ester such as methyl methacrylate, acrylonitrile, or methacrylonitrile, a rubber-modified styrene-based resin (HIPS), an acrylonitrile-butadiene-styrene copolymer resin (ABS), and a methacrylic acid ester-butadiene-styrene copolymer resin (MBS).

Other examples of the thermoplastic resin (III) include a polymer of acrylic acid and an ester or amide thereof, a polyacrylate-based resin, a polymer of acrylonitrile and/or methacrylonitrile, a nitrile resin that is a copolymer of another copolymerizable monomer having a content of 50% by mass or more of such an acrylonitrile-based monomer, a polyamide-based resin such as nylon-46, nylon-6, nylon-66, nylon-610, nylon-11, nylon-12, or nylon-6-nylon-12 copolymer, a polyester-based resin, a thermoplastic polyurethane-based resin, a polycarbonate-based polymer such as poly-4,4′-dioxydiphenyl-2,2′-propane carbonate, thermoplastic polysulfone such as polyethersulfone or polyallylsulfone, a polyoxymethylene-based resin, a polyphenylene ether-based resin such as poly(2,6-dimethyl-1,4-phenylene)ether, a polyphenylene sulfide-based resin such as polyphenylene sulfide, or poly 4,4′-diphenylene sulfide, a polyarylate-based resin, a polyether ketone polymer or copolymer, a polyketone-based resin, a fluorine-based resin, a polyoxy benzoyl-based polymer, a polyimide-based resin, and a polybutadiene-based resin such as 1,2-poly butadiene and trans-poly butadiene.

As the thermoplastic resins (III), polystyrene, a styrene-based resin such as a rubber-modified styrene-based resin, a polyamide-based resin, a polyester-based resin, and a polycarbonate-based resin are particularly preferred. The number average molecular weights of thermoplastic resins (III) are generally 1,000 or more, preferably 5,000 to 5,000,000, and more preferably 10,000 to 1,000,000.

### <Softener (IV)>

The hydrogenated block copolymer composition contained in the foam body of the present embodiment contains the softener (IV).

The softener (IV) is preferably a rubber softener that softens the hydrogenated block copolymer composition as well as imparts flowability and processability thereto.

The rubber softener may be, but is not limited to, for example, a mineral oil or a liquid or low molecular weight synthetic softener, and in particular, naphthene-based and/or paraffin-based process oils or extender oils are preferred.

A mineral oil-based rubber softener is a mixture of an aromatic ring, a naphthene ring, and a paraffin chain, and a softener containing a paraffin chain having a carbon number corresponding to 50% or more of all carbons is designated as a paraffin-based softener, a softener containing a naphthene ring having a carbon number corresponding to 30 to 45% is designated as a naphthene-based softener, and a softener having an aromatic carbon number over 30% is designated as an aromatic softener.

In the hydrogenated block copolymer composition of the present embodiment, a synthetic softener may be used, and examples of the synthetic softener include, but are not limited to, polybutene, low molecular weight polybutadiene, and liquid paraffin. As the softener (IV), the mineral oil-based rubber softener is more preferred.

When the hydrogenated block copolymer composition contained in the foam body of the present embodiment is required of high heat resistance and mechanical properties, a mineral oil-based rubber softener to be used therein has a kinematic viscosity at 40° C. of preferably 60 cst or more, and more preferably 120 cst or more.

One of such softeners (IV) may be singly used, or two or more of these may be used together.

### <Contents of Components (I) to (IV) in Hydrogenated Block Copolymer Composition>

The contents of the component (I) to (IV) in the hydrogenated block copolymer composition contained in the foam body of the present embodiment will now be described.

The content of the hydrogenated block copolymer (I) is preferably 3% by mass or more and 95% by mass or less, more preferably 5% by mass or more and 70% by mass or less, further preferably 7% by mass or more and 60% by mass or less, and still further preferably 9% by mass or more and 50% by mass or less.

When the content of the hydrogenated block copolymer (I) in the hydrogenated block copolymer composition falls in the above-described range, foams tend to be fine and highly independent to have a high foaming property in molding the foam body. Therefore, thermal insulation is improved, and hence excellent foam stability, molding processability, and wear resistance for a long period of time tend to be obtained.

The content of the olefin-based resin (II) is preferably 1% by mass or more and 42% by mass or less, more preferably 3% by mass or more and 38% by mass or less, further preferably 6% by mass or more and 34% by mass or less, and still further preferably 10% by mass or more and 30% by mass or less.

When the content of the olefin-based resin (II) falls in the above-described range, balance among the foaming property, the flexibility, and the heat resistance tends to be good.

The content of the thermoplastic resin (III) is preferably 1% by mass or more and 60% by mass or less, more preferably 3% by mass or more and 50% by mass or less, further preferably 6% by mass or more and 40% by mass or less, and still further preferably 10% by mass or more and 30% by mass or less.

When the content of the thermoplastic resin (III) falls in the above-described range, balance among the foaming property, the flexibility, the molding processability, and the toughness tends to be good.

The content of the softener (IV) is preferably 1% by mass or more and 65% by mass or less, more preferably 5% by mass or more and 60% by mass or less, further preferably 10% by mass or more and 55% by mass or less, and still further preferably 20% by mass or more and 50% by mass or less.

When the content of the softener (IV) falls in the above-described range, balance among the foaming property, the flexibility, and the molding processability tends to be good.

### <Additive>

In the hydrogenated block copolymer composition contained in the foam body of the present embodiment, in addition to the components (I), (II), (III), and (IV), an arbitrary additive can be compounded if necessary.

The type of the additive is not especially limited as long as it is generally used to be compounded in a thermoplastic resin or a rubbery polymer.

The additive is not especially limited, and can be a filler, a lubricant, a releasing agent, a plasticizer, an antioxidant, a heat stabilizer, a light stabilizer, a UV absorber, a flame retardant, an antistatic agent, a reinforcing agent, a colorant and the like that are generally used in a thermoplastic resin and a rubbery polymer.

Examples of the filler include, but are not limited to, inorganic fillers such as silica, talc, mica, calcium silicate, hydrotalcite, kaolin, diatomite, graphite, calcium carbonate, magnesium carbonate, magnesium hydroxide, aluminum hydroxide, calcium sulfate, and barium sulfate, and organic fillers such as carbon black.

Examples of the lubricant include, but are not limited to, stearic acid, behenic acid, zinc stearate, calcium stearate, magnesium stearate, and ethylene-bis-stearamide.

Examples of the plasticizer include, but are not limited to, organic polysiloxane and mineral oil.

An example of the antioxidant includes, but is not limited to, a hindered phenol-based antioxidant.

Examples of the heat stabilizer include, but are not limited to, phosphorus-based, sulfur-based and amine-based heat stabilizers.

An example of the light stabilizer includes, but is not limited to, a hindered amine-based light stabilizer.

An example of the UV absorber includes, but is not limited to, a benzotriazole-based UV absorber.

Examples of the reinforcing agent include, but are not limited to, organic fiber, glass fiber, carbon fiber, and metal whisker.

Examples of the colorant include, but are not limited to, titanium oxide, iron oxide, and carbon black.

The other examples include those described in, for example, “Gomu/Plastic Haigo Yakuhin (Rubber/Plastic Compounding Chemicals)” (edited by Rubber Digest Co., Ltd.).

### (Method for Producing Hydrogenated Block Copolymer Composition)

The hydrogenated block copolymer composition contained in the foam body of the present embodiment can be produced by a conventionally known method.

Examples of a production method of the hydrogenated block copolymer composition of the present embodiment include, but are not limited to, a method in which respective components (the hydrogenated block copolymer (I), the polyolefin-based resin (II), the thermoplastic resin (III), the softener (IV), and another additive if necessary) are melt kneaded using a mixer, such as a Bunbury mixer, a single screw extruder, a twin screw extruder, a Ko Kneader, or a multi-screw extruder, and a method in which the respective components are dissolved or dispersed in a solvent to be mixed, followed by removal of the solvent by heating.

In particular, a melt kneading method using an extruder is suitably employed from the viewpoints of productivity and good kneadability.

The shape of the hydrogenated block copolymer composition can be, but is not limited to, an arbitrary shape such as a pellet shape, a sheet shape, a strand shape, or a chip shape. After the melt kneading, a molded article may be directly produced.

### (Hardness of Hydrogenated Block Copolymer Composition)

The hydrogenated block copolymer composition contained in the foam body of the present embodiment has a value of 15 seconds hardness measured with a type A durometer in accordance with JIS K6253 of 85 or less, preferably 80 or less, more preferably 75 or less, and further preferably 70 or less.

When the value of 15 seconds hardness, measured with a type A durometer in accordance with JIS K6253, of the hydrogenated block copolymer composition contained in the foam body of the present embodiment is 85 or less, the foam body of the present embodiment can obtain very good cushioning feeling and soft sense of touch.

The hydrogenated block copolymer composition contained in the foam body of the present embodiment has a value of 15 seconds hardness measured with a type A durometer in accordance with JIS K6253 of preferably 30 or more, more preferably 35 or more, and further preferably 40 or more. Thus, a pellet of the hydrogenated block copolymer composition tends to exhibit good blocking resistance.

When the blocking resistance of pellets of the hydrogenated block copolymer composition is high, the blocking tends to be difficult to occur even under conditions during transportation of a longer time, a larger load, and more severe temperature environment as in, for example, a region with a high outside temperature, or a region with a wide range of temperature, and it can be expected that the pellets can be easily weighed, blended or the like in molding the compound. Besides, since the amount of the anti-tack agent to be added can be reduced, device pollution can be avoided, environmental load can be reduced, and unexpected degradation of physical properties, for example, degradation of transparency, mechanical strength, or the like, can be expected to be suppressed.

The hardness of the hydrogenated block copolymer composition can be controlled to fall in the above-described numerical range by adjusting the hardness of the hydrogenated block copolymer (I) contained in the hydrogenated block copolymer composition, the hardness of the component (III) in the hydrogenated block copolymer composition, the flexural strength of the component (II), the viscosity of the component (IV), and the composition ratio among the components (I) to (IV).

The hardness of the hydrogenated block copolymer (I) can be controlled by appropriately adjusting the weight average molecular weight of the hydrogenated block copolymer (I), the content of the polymer block (a) in the hydrogenated block copolymer composition, the content of the vinyl aromatic monomer unit in the hydrogenated copolymer block (b), the content of the hydrogenated polymer block (c), the vinyl bond content in the conjugated diene monomer unit of the hydrogenated block copolymer (I), the hydrogenation rate of a double bond of the conjugated diene monomer unit of the hydrogenated block copolymer (I), and the like.

Alternatively, the hardness of the hydrogenated block copolymer (I) may be controlled by adjusting a tan δ peak temperature (loss tangent) at −25° C. to 60° C. in a viscoelasticity measurement chart of the hydrogenated block copolymer (I), namely, by adjusting a glass transition temperature derived from the hydrogenated copolymer block (b), by performing a polymerization reaction using a prescribed modifier for adjusting the vinyl bond content of the hydrogenated copolymer block (b), adjusting the content of the vinyl aromatic monomer unit in the hydrogenated copolymer block (b), and adjusting the copolymerizability between the vinyl aromatic compound and the conjugated diene.

### (MFR of Hydrogenated Block Copolymer Composition)

The hydrogenated block copolymer composition contained in the foam body of the present embodiment has an MFR measured under conditions of a temperature of 230° C. and a load of 2.16 kg in accordance with JIS K7210 of 40 or more, preferably 60 or more, and more preferably 100 or more.

When the MFR of the hydrogenated block copolymer composition contained in the foam body of the present embodiment is 40 or more, good processability tends to be exhibited.

When the processability of the hydrogenated block copolymer composition contained in the foam body of the present embodiment is good, the foam body can be molded as a very thin layer, and in particular, a foam body having a thin non-foam skin layer can be obtained. Besides, a striped pattern such as a flow mark, a pock mark, and a swirl mark are difficult to be formed in the molding of a foam body, and hence a foam body having a good surface appearance can be obtained. Furthermore, molding can be performed using a more complicated mold, or using a thin mold, and hence the weight of the resultant article can be reduced owing to thickness reduction. Furthermore, higher processability tends to be advantageous to improvement of surface appearance, molding using a complicated mold, and thickness reduction.

In addition, as the processability is higher, the amount of a processing aid such as the softener (IV) used in the hydrogenated block copolymer composition can be reduced, and therefore, there is a tendency that the freedom in compounding is improved, mechanical strength and sense of touch of the hydrogenated block copolymer composition are improved, and an effect of reducing environmental load can be obtained.

The upper limit of the MFR of the hydrogenated block copolymer composition contained in the foam body of the present embodiment is preferably 2,000 or less, more preferably 1,000 or less, and further preferably 500 or less from the viewpoint of heat resistance retention.

The MFR of the hydrogenated block copolymer composition can be controlled to fall in the above-described numerical range by adjusting the MFRs of the components (I), (II), and (III) in the hydrogenated block copolymer composition, the viscosity of the component (IV), and the composition ratio among the components (I) to (IV).

The MFR of the hydrogenated block copolymer (I) is controlled by adjusting the weight average molecular weight, the content of the polymer block (a), the content of the vinyl aromatic monomer unit in the hydrogenated copolymer block (b), the content of the hydrogenated polymer block (c), the vinyl bond content in the conjugated diene monomer unit before hydrogenation of the hydrogenated block copolymer (I), and the hydrogenation rate of a double bond of the conjugated diene monomer unit of the hydrogenated block copolymer (I).

For example, the MFR of the hydrogenated block copolymer (I) tends to be increased when the weight average molecular weight of the hydrogenated block copolymer (I) is reduced, the content of the polymer block (a) is reduced, the content of the vinyl aromatic monomer unit in the hydrogenated copolymer block (b) is increased, the content of the hydrogenated polymer block (c) in a terminal block is increased, the content of the hydrogenated polymer block (c) in an internal block is reduced, the vinyl bond content in the conjugated diene monomer unit is increased, or the hydrogenation rate of a double bond of the conjugated diene monomer unit is reduced.

In particular, the weight average molecular weight of the hydrogenated block copolymer (I) is in a linear relationship with a logarithm of the MFR. Therefore, after adjusting the content of the polymer block (a) in the hydrogenated block copolymer (I) and the content of the vinyl aromatic monomer unit in the hydrogenated copolymer block (b) for exhibiting the blocking resistance of a pellet of the hydrogenated block copolymer composition, and the heat resistance and the wear resistance of the hydrogenated block copolymer composition, a weight average molecular weight for attaining a desired MFR may be determined based on the linear relationship between the weight average molecular weight of the hydrogenated block copolymer (I) and the logarithm of the MFR.

### [Method for Producing Foam Body]

A method for producing a foam body of the present embodiment includes a step of adding a foaming agent (V) to the hydrogenated block copolymer composition, and injecting the resultant to fill a cavity, which is formed in a mold of an injection molding machine, and has a space volume adjustable with a movable core, and a step of increasing the space volume of the cavity with the movable core to perform foam molding.

Specifically, the hydrogenated block copolymer composition is injected into a cavity space formed within a mold, and immediately after, or after a prescribed time period, a movable mold or a movable core provided in the movable mold is restored to a prescribed position at a prescribed rate. Thus, the hydrogenated block copolymer composition expands within the cavity space, and thus, the foam molding is conducted.

A foaming method can be a chemical method or a physical method, and in either method, after adding a chemical foaming agent such as an inorganic foaming agent or an organic foaming agent, or a physical foaming agent, the foaming agent is volatilized and/or decomposed by heating or the like, so that foams are distributed in the hydrogenated block copolymer composition.

The foam body of the present embodiment can be produced by, for example, core back injection molding, and is characterized in that the non-foam skin layer and the foam core layer are integrally molded, and that the foam core layer and the non-foam skin layer are adjacent to each other. When core back injection molding is employed, a foam core layer having a cushioning property, and a non-foam skin layer having design, and harder than the foam core layer can be molded in one and the same process, and therefore, this method is effective for reducing molding processes. Besides, a counter-pressure device may be used for the purpose of eliminating a swirl mark formed on the surface of the foam body.

### (Foaming Agent (V))

As the foaming agent (V), an inorganic foaming agent, an organic foaming agent, or a physical foaming agent can be used.

Examples of the inorganic foaming agent include, but are not limited to, sodium bicarbonate, ammonium carbonate, ammonium bicarbonate, ammonium nitrite, an azide compound, sodium borohydride, aluminum acetate, and a metal powder.

Examples of the organic foaming agent include, but are not limited to, azodicarbonamide, azobisformamide, azobisisobutyronitrile, barium azodicarboxylate, N,N′-dinitrosopentamethylenetetramine, N,N′-dinitroso-N,N′-dimethylterephthalamide, benzenesulfonyl hydrazide, p-toluenesulfonyl hydrazide, p,p′-oxybisbenzenesulfonyl hydrazide, and p-toluenesulfonyl semicarbazide.

Examples of the physical foaming agent include, but are not limited to, hydrocarbons such as pentane, butane, and hexane: halogenated hydrocarbons such as methyl chloride and methylene chloride: a gas such as nitrogen, carbon dioxide, and air; and fluorinated hydrocarbons such as trichlorofluoromethane, dichlorodifluoromethane, trichlorotrifluoroethane, chlorodifluoroethane, and hydrofluorocarbon.

These foaming agents (V) may be used in combination.

An amount of the foaming agent (V) to be compounded is preferably 0.1 to 30 parts by mass, more preferably 2 to 25 parts by mass, and further preferably 3 to 20 parts by mass with respect to 100 parts by mass of the hydrogenated block copolymer composition.

### (Foaming Aid)

In the process for producing the foam body, a foaming aid may be used together with the foaming agent (V) described above.

The foaming aid is not especially limited, and those generally conventionally used as a foaming aid can be used.

Examples include a urea compound, a zinc compound such as zinc oxide, zinc stearate, zinc benzenesulfinate, zinc toluenesulfonate, zinc trifluoromethanesulfonate, and zinc carbonate, and a lead compound such as lead dioxide, and tribasic lead.

When the foaming agent (V) and the foaming aid are used together, the amount of the foaming aid to be compounded is, with respect to 100 parts by mass of the foaming agent, preferably 0.1 to 1,000 parts by mass, more preferably 0.5 to 500 parts by mass, and further preferably 1 to 200 parts by mass.

### (Nucleating Foaming Agent)

In the process for producing the foam body, a nucleating foaming agent may be used.

The nucleating foaming agent is not especially limited, and those generally conventionally used as a nucleating foaming agent can be used.

Examples include titanium oxide, talc, kaolin, clay, calcium silicate, silica, sodium citrate, calcium carbonate, diatomite, calcined perlite, zeolite, bentonite, glass, limestone, calcium sulfate, aluminum oxide, titanium oxide, magnesium carbonate, sodium carbonate, ferrous carbonate, and a polytetrafluoroethylene powder.

An amount of the nucleating foaming agent to be compounded is preferably 0.01 to 100 parts by mass, more preferably 0.05 to 50 parts by mass, and further preferably 0.1 to 10 parts by mass with respect to 100 parts by mass of the hydrogenated block copolymer composition.

### [Structure of Foam Body]

The foam body of the present embodiment can be produced by core back injection molding as described above. The foam body of the present embodiment has a structure in which the non-foam skin layer and the foam core layer are integrally molded, and the foam core layer having a cushioning property, and the non-foam skin layer harder than the foam core layer are adjacent to each other.

### (Foaming Ratio)

The foaming ratio of the foam body of the present embodiment is 1.2-fold or more, preferably 1.5-fold or more, more preferably 1.7-fold or more, further preferably 1.9-fold or more, and still further preferably 2-fold or more.

When the foaming ratio is 1.2-fold or more, an excellent cushioning property, and excellent appearance can be obtained.

The foaming ratio of the foam body can be calculated as a value obtained by dividing the thickness (mm) of the foam core layer of the foam body after the core back injection molding by the thickness (mm) of a void portion of a cavity in a mold of an injection molding machine in filling the cavity with the hydrogenated block copolymer composition.

The foaming ratio of the foam body can be controlled to fall in the above-described numerical range by adjusting, in the production process of the foam body, the types and compositions of the components (I) to (IV) in the hydrogenated block copolymer composition, the type and the amount of the foaming agent (V) to be added, the amount of the hydrogenated block copolymer composition to be filled, and the molding temperature and pressure employing in the molding process.

Particularly in employing the core back injection molding, the foaming ratio can be controlled to fall in the above-described numerical range by appropriately adjusting, in the production process of the foam body, the types and the compositions of the components (I) to (IV) in the hydrogenated block copolymer composition, the type of the foaming agent (V), the amount of the hydrogenated block copolymer composition to be filled, the core back opening, the amount of the foaming agent to be added, the temperature of the hydrogenated block copolymer composition to be injected, the temperature of the mold (a fixed portion/a movable portion), an injection speed, an injection pressure, a delay time after the filling to start of the core back, the number of core back stages, the opening and the core back speed at each stage, a cooling time, and the shape of the mold.

### (Non-Foam Skin Layer)

The foam body of the present embodiment has the structure in which the foam core layer and the non-foam skin layer are adjacent to each other.

The thickness of the non-foam skin layer is, from the viewpoint of obtaining good cushioning property and molded appearance, preferably 10 μm to 1,000 μm, more preferably 10 μm to 700 μm, and further preferably 10 μm to 500 μm.

When the foam body of the present embodiment is produced by the core back injection molding, the thickness of the non-foam skin layer can be controlled to fall in the above-described numerical range by appropriately adjusting, in the production process of the foam body, the types and the compositions of the components (I) to (IV) in the hydrogenated block copolymer composition, the type of the foaming agent (V), the amount of the hydrogenated block copolymer composition to be filled, the core back opening, the amount of the foaming agent to be added, the temperature of the resin to be injected, the temperature of the mold (a fixed portion/a movable portion), an injection speed, an injection pressure, a delay time after the filling to start of the core back, the number of core back stages, the opening and the core back speed at each stage, a cooling time, and the shape of the mold.

### (Foam Core Layer)

The foam body of the present embodiment has the structure in which the foam core layer and the non-foam skin layer are adjacent to each other.

The thickness of the foam core layer is, from the viewpoint of obtaining a good cushioning property, 300 μm or more, preferably 700 μm or more, and more preferably 1,000 μm or more. The upper limit of the thickness of the foam core layer is not especially limited, and is preferably 20,000 μm or less.

In employing the core back injection molding, in order to perform the molding for obtaining a good molded appearance (free from a flow mark, a swirl mark, a pock mark, and a sink mark), the thickness of the foam core layer can be controlled to fall in the above-described numerical range by appropriately adjusting, in the production process of the foam body, the types and the compositions of the components (I) to (IV) in the hydrogenated block copolymer composition, the type of the foaming agent (V), the amount of the hydrogenated block copolymer composition to be filled, the core back opening, the amount of the foaming agent to be added, the temperature of the resin to be injected, the temperature of the mold (a fixed portion/a movable portion), an injection speed, an injection pressure, a delay time after the filling to start of the core back, the number of core back stages, the opening and the core back speed at each stage, a cooling time, and the shape of the mold.

### [Use of Foam Body]

The foam body of the present embodiment can be used in, for example, a vehicle component, a food packaging material, a medical instrument, a member of home appliances, an electronic device member, a building material, an industrial component, a household article, a toy material, a footwear material, a fiber material and the like.

Examples of the vehicle component include, but are not limited to, a side mall, a grommet, a shift knob, a weather strip, a window frame and its sealing material, a dashboard, an assist grip, a steering wheel, a shift lever, a console, an arm rest, a head rest, and a door panel.

Examples of the medical instrument include, but are not limited to, a medical tube, a medical hose, a catheter, a blood bag, an infusion bag, a platelet storage bag, and a dialysis bag.

Examples of the building material include, but are not limited to, a wall material and a floor material.

The other examples include, but are not limited to, an industrial hose, a hose for food, a hose for a vacuum cleaner, an electrically cooling gasket, various coating materials for an electrical wire and the like, a coating material for a grip, and a soft doll.

The foam body of the present embodiment may be appropriately subjected to processing such as foaming, powdering, extending, adhering, printing, coating, or plating.

### [Laminate]

A laminate of the present embodiment includes a layer containing the foam body of the present embodiment, and a layer containing a base resin.

Examples of the base resin include, but are not limited to, polypropylene, polyethylene, methyl polymethacrylate, polyacrylonitrile, polymethacrylonitrile, a rubber-modified styrene-based resin (HIPS), an acrylonitrile-butadiene-styrene copolymer resin (ABS), and a methacrylic acid ester-butadiene-styrene copolymer resin (MBS).

The base resin is particularly preferably polypropylene or an ABS resin from the viewpoint of causing the laminate of the present embodiment to exhibit good rigidity.

The layer containing the foam body may consist only of the foam body of the present embodiment, or may be a laminate with another material layer.

The layer containing the base resin may consist only of the base resin, or may be a laminate of the base resin with another resin, or may contain a mixed resin of the base resin and another resin.

An example of a method for laminating the layer containing the foam body and the layer containing the base resin includes a method in which the base resin is injection molded, and then is subjected to core back injection molding with the hydrogenated block copolymer composition of the present embodiment by two-color injection molding. As a result, the layer containing the base resin and the layer containing the foam body exhibit good adhesiveness, and hence, the laminate can be obtained without via an adhesive layer. Thus, it is possible to reduce molding processes of the laminate, and the recyclability can be improved.

It is noted that the laminate of the present embodiment may have the aforementioned structure in which the layer containing the base resin and the layer containing the foam body are in direct contact with each other without an adhesive layer therebetween, or may have a structure in which these layers are laminated via a prescribed adhesive layer.

### Examples

Now, the present embodiment will be described in detail with reference to specific examples and comparative examples, and it is noted that the present invention is not limited to these examples and comparative examples.

Measurement methods and evaluation methods of physical properties applied in the examples and comparative examples are as follows.

The structure specification and the physical property measurement of hydrogenated block copolymers used in foam bodies of the examples and comparative examples were conducted as follows.

### [Method for Specifying Structure of Hydrogenated Block Copolymer]

### ((1) Content of all Vinyl Aromatic Monomer Units (Styrene) in Hydrogenated Block Copolymer (I))

A hydrogenated block copolymer was used to measure a content of all vinyl aromatic monomer units (styrene) with a UV spectrophotometer (UV-2450, manufactured by Shimadzu Corporation).

### ((2) Hydrogeneration Rate of Double Bond of Conjugated Diene Monomer Unit in Hydrogenated Block Copolymer (I))

A hydrogenation rate of a double bond of the conjugated diene monomer unit was measured by using the hydrogenated block copolymer with a nuclear magnetic resonance apparatus (ECS400, manufactured by JEOL RESONANCE Inc.).

### ((3) Content of Polymer Block (a) in Hydrogenated Block Copolymer (I))

The content of the polymer block (a) principally containing a vinyl aromatic monomer unit was measured by using the hydrogenated block copolymer with a nuclear magnetic resonance apparatus (NMR) (by a method described in Y. Tanaka, et al., RUBBER CHEMISTRY and TECHNOLOGY, 54, 685 (1981); hereinafter referred to as the “NMR method”).

### ((4) Content of Hydrogenated Copolymer Block (b) in Hydrogenated Block Copolymer (I))

The content of the hydrogenated copolymer block (b) in the hydrogenated block copolymer (I) was calculated in accordance with a calculation formula, 100−(content of hydrogenated copolymer block (a) in hydrogenated block copolymer (I)).

### ((5) Vinyl Bond Content in Hydrogenated Block Copolymer (I))

The vinyl bond content was measured by using the hydrogenated block copolymer with a nuclear magnetic resonance apparatus (NMR).

The vinyl bond content in the conjugated diene monomer unit in the hydrogenated block copolymer was obtained based on a ratio of a total area of 1,2-bond and 3,4-bond peaks to a total area of all peaks involved in the conjugated diene monomer unit (1,2-bond, 3,4-bond, and 1,4-bond peaks) among peaks obtained by NMR measurement.

### ((6) Content of Vinyl Aromatic Monomer Unit in Hydrogenated Copolymer Block (b) Contained in Hydrogenated Block Copolymer (I))

Based on a difference between the content of all vinyl aromatic monomer units in the hydrogenated block copolymer (I) measured as described in (1) above, and the content of the polymer block (a) principally containing a vinyl aromatic monomer unit in the hydrogenated block copolymer (I) measured as described in (3) above, the content of the vinyl aromatic monomer unit in the hydrogenated copolymer block (b) in the entire polymer was calculated, and based on a ratio to the content of the hydrogenated copolymer block (b) in the hydrogenated block copolymer (I) measured as described in (4) above, the content of the vinyl aromatic monomer unit in the hydrogenated copolymer block (b) was calculated.

### [Methods for Measuring Physical Properties of Hydrogenated Block Copolymer]

### ((1) Hardness)

Values of 15 seconds hardness were measured respectively with a type A durometer and a type D durometer in accordance with JIS K6253.

A hardness value obtained 15 seconds after a probe of the durometer touched a measurement sample was measured.

In Tables 1 to 2 below, these hardness values are shown respectively as Hardness (JIS-A, 15 seconds) and Hardness (JIS-D, 15 seconds).

When the hardness measured with the type D durometer had a value less than 20, the value obtained with the type A durometer was used as the hardness value, and when the hardness measured with the type A durometer had a value over 90, the value obtained with the type D durometer was used.

As a guide, hardness of 94 measured with a type A durometer corresponds to hardness of 45 measured with a type D durometer.

((2) Melt Flow Rate (MFR, Unit: g/10 Min))

An MFR was measured under conditions of a temperature of 230° C. and a load of 2.16 kg in accordance with JIS K7210.

### [Method for Measuring Physical Properties of Hydrogenated Block Copolymer Composition]

Hydrogenated block copolymer compositions used in the foam bodies of the examples and comparative examples were measured for physical properties as follows.

### ((1) Hardness)

A value of 15 seconds hardness was measured with a type A durometer in accordance with JIS K6253.

A hardness value obtained 15 seconds after a probe of the durometer touched a measurement sample was measured.

In Tables 3 to 12 below, the thus obtained hardness is shown as Hardness (JIS-A, 15s).

### ((2) MFR)

A MFR was measured in accordance with JIS K7210 under conditions of a temperature of 230° C. and a load of 2.16 kg.

### [Physical Property Measurement and Property Evaluation of Foam Body]

Physical property measurement and property evaluation of the foam bodies of the examples and comparative examples were conducted as follows.

### ((1) Foaming Ratio)

The foaming ratio was calculated as a value obtained by dividing the thickness (mm) of the foam core layer of each foam body after core back injection molding by the thickness (mm) of a void portion of a cavity in a mold of an injection molding machine in filling the cavity with the hydrogenated block copolymer composition.

### ((2) Measurement of Thickness of Non-Foam Skin Layer)

Each foam body was cut in the thickness direction vertically to the injection plane, and the resultant cross section was observed with an optical microscope.

The thickness of the skin layer was measured on the observed section.

### ((3) Measurement of Thickness of Foam Core Layer)

Each foam body was cut in the thickness direction vertically to the injection plane, and the resultant cross section was observed with an optical microscope.

The thickness of the core layer was measured on the observed section.

### ((4) Wear Resistance on Surface of Foam Body)

A color fastness rubbing tester (AB-301, manufactured by Tester Sangyo Co., Ltd.) was used to rub a leather-textured surface of each foam body obtained by the core back injection molding with a rubbing cloth canequim #3 under a load of 1,000 g, and the wear resistance was evaluated in accordance with a volume decrease caused by the rubbing based on the following criteria:

### <Evaluation Criteria>

4: A volume decrease caused by 1,000 times of rubbing was less than 50 mg.
3: A volume decrease caused by 1,000 times of rubbing was 50 mg or more and less than 150 mg.
2: A volume decrease caused by 1,000 times of rubbing was 150 mg or more and less than 250 mg.
1: A volume decrease caused by 1,000 times of rubbing was 250 mg or more.

Regarding the wear resistance, an acceptable score is 2 or more, and such a score was evaluated to be excellent, from the viewpoints of improvement of durability and improvement of the compounding freedom, when a thinner/more complicated molded article is used, and when the foam body is rubbed with a larger load, or with a coarse fabric.

When the wear resistance is good, the composition can be used in a use, as a vehicle material and the like, requiring more severe wear resistance. For example, in a use as a vehicle interior material or the like, also in molding into a smaller thickness or in molding a more complicated/larger molded article, appearance retention can be expected even in a long-term use comparably to a compact general molded article in a simple shape.

Besides, when the hydrogenated block copolymer composition is used as a vehicle interior material, assuming the time of a ride, even if the material is subjected to friction with a larger load or with a coarse fabric (such as a jeans fabric that is a fabric coarser than a cotton fabric of canequim #3), it can be expected that the appearance of the material can be retained for a long period of time.

### ((5) Surface Appearance of Foam Body)

It was confirmed, in the foam body obtained by the injection molding of the hydrogenated block copolymer composition, whether or not there was a flow mark, a pock mark (gas release), or a swirl mark, or transfer unevenness such as a leather-like surface, or a sink mark caused by the mold.

In the evaluation of the appearance, a sample having no practical problem was scored as 3, a sample that was slightly defective and might have a practical problem was scored as 2, and a sample that was noticeably defective and had a practical problem was scored as 1.

The acceptable score was determined as 2 or more.

### ((6) Cushioning Property of Foam Body)

It was determined, by 5 measurers, whether or not the foam body was dented when pressed with a finger.

A sample having a high cushioning property was scored as 3, a sample having an intermediate cushioning property was scored as 2, and a sample having no cushioning property was scored as 1, and the evaluation was conducted based on the following criteria:

### <Evaluation Criteria>

5: The total score was 15.
4: The total score was 12 to 14.
3: The total score was 9 to 11.
2: The total score was 6 to 8.
1: The total score was 5.

The acceptable score was determined as 2 or more, and such a sample was evaluated as a cushioning foam body.

### [Foam Body]

A foam body was produced using a hydrogenated block copolymer (I), an olefin-based resin (II), a thermoplastic resin (III), and a softener (IV) described below.

### (Production of Hydrogenated Block Copolymer (I))

### <Preparation of Hydrogenation Catalyst>

A hydrogenation catalyst to be used in producing a hydrogenated block copolymer in an example and a comparative example described later was prepared as follows.

A reaction vessel equipped with a stirrer having been replaced with nitrogen was charged with 1 liter of dried and purified cyclohexane.

Next, 100 mmol of bis(η5-cyclopentadienyl)titanium dichloride was added thereto.

A n-hexane solution containing 200 mmol of trimethyl aluminum was added to the resultant under sufficient stirring, followed by a reaction at room temperature for about 3 days. Thus, a hydrogenation catalyst was obtained.

### Production Example 1: Hydrogenated Block Copolymers (I)-1

A tank reactor (having a capacity of 10 L) equipped with a stirrer and a jacket was used for performing batch polymerization.

First, a cyclohexane solution (concentration of 20% by mass) containing 15 parts by mass of styrene was charged.

Next, n-butyllithium was added in a ratio of 0.107 parts by mass with respect to 100 parts by mass of all monomers, N,N,N′,N′-tetramethylethylenediamine (hereinafter referred to as the “TMEDA”) was added in a ratio of 0.9 moles per mole of n-butyllithium, and the resultant was polymerized at 65° C. for 1 hour.

Next, a cyclohexane solution (concentration of 20% by mass) containing 29 parts by mass of butadiene and 41 parts by mass of styrene was added thereto, followed by polymerization at 80° C. for 2 hours. Finally, a cyclohexane solution (concentration of 20% by mass) containing 15 parts by mass of styrene was added thereto, followed by polymerization at 65° C. for 1 hour. Thereafter, methanol was added thereto to stop the polymerization reaction.

A block copolymer obtained in this manner had a styrene content of 71% by mass, a polystyrene block content of 30% by mass, a vinyl bond content of 22% by mass, and a weight average molecular weight of 60,000.

To the thus obtained block copolymer, the hydrogenation catalyst prepared as described above was added in an amount of 100 ppm, in terms of Ti, per 100 parts by mass of the block copolymer, followed by a hydrogenation reaction at a hydrogen pressure of 0.7 MPa and a temperature of 65° C.

Next, octadecyl-3-(3,5-di-t-butyl-4-hydroxyphenyl) propionate, used as a stabilizer, was added in an amount of 0.3 parts by mass with respect to 100 parts by mass of the block copolymer to obtain a hydrogenated block copolymer (I)-1.

The hydrogenated block copolymer (I)-1 thus obtained had a hydrogenation rate of 98%. The other physical properties thereof are shown in Table 1.

### Production Examples 2 to 16: Hydrogenated Block Copolymers (I)-2 to 13, (I)-A to C

In the method for producing the hydrogenated block copolymer (I)-1, the polymerization method and the hydrogenation condition were adjusted to produce hydrogenated block copolymers (I)-2 to (I)-13, and (I)-A to (I)-C. The physical properties of these are shown in Tables 1 and 2 below.

### [Production of Hydrogenated Block Copolymer Composition]

Hydrogenated block copolymer compositions were produced by respectively using the hydrogenated block copolymers (I)-1 to (I)-13, and (I)-A to C, and the following components (II) to (IV).

### (Olefin-based Resin (II))

### <Component (II)-1>

Olefin-based resin: polypropylene resin, PM801A (manufactured by Sum Allomer, Ltd.)

### <Component (II)-2>

Olefin-based resin: polypropylene resin, PMB00A (manufactured by Sum Allomer, Ltd.)

### <Component (II)-3>

Olefin-based resin: polypropylene resin, PL500A (manufactured by Sum Allomer, Ltd.)

### (Thermoplastic Resin (III))

### <Component (III)-1>

Thermoplastic resin: styrene-based thermoplastic elastomer, N504 (manufactured by Japan Elastomer Co., Ltd.)

### <Component (III)-2>

### Thermoplastic Resin: Styrene-Based Thermoplastic Elastomer

Content of polymer block (a): 35% by mass, content of hydrogenated copolymer block (b): 65% by mass, content of vinyl aromatic compound in hydrogenated copolymer block (b): 21% by mass, average molecular weight: 250,000, vinyl bond content: 35% by mass, hydrogenation rate: 98% by mass

### (Softener (IV))

### <Component (IV)>

Softener: paraffin oil, PW-90 (manufactured by Idemitsu Kosan Co., Ltd.)

### [Production of Hydrogenated Block Copolymer Composition, and Foam Body]

### Example 1

### <Production of Hydrogenated Block Copolymer Composition>

The hydrogenated block copolymer (I)-1 formed into a pellet shape, the olefin-based resin (II), the thermoplastic resin (III), and the softener (IV) were compounded in a ratio (parts by mass) shown in Table 3, the resultant was kneaded with a twin screw extruder (TEX-30) into a pellet shape, and thus, a hydrogenated block copolymer composition was obtained.

Conditions for extrusion were a cylinder temperature of 230° C., and a screw speed of 300 rpm.

The thus obtained hydrogenated block copolymer composition was used, and injection molded at 210° C. to produce an injection molded sheet having a thickness of 2 mm, and thus, a physical property measurement sample was obtained.

Results of the physical property measurement are shown in Table 3.

### Examples 2 to 36, and Comparative Examples 1 to 7

### <Production of Hydrogenated Block Copolymer Composition>

Hydrogenated block copolymer compositions were produced in the same manner as in Example 1 described above except that the respective components were changed as shown in Tables 3 to 12, and their physical properties were measured.

Results of the physical property measurement are shown in Tables 3 to 12.

### (Production of Foam Bodies of Examples 1 to 36 and Comparative Examples 1 to 7)

To the pellets of the hydrogenated block copolymer compositions produced based on the compounding ratios (parts by mass) shown in Tables 3 to 12, a sodium bicarbonate-based foaming agent, Polythrene EE-25C (manufactured by EIWA CHEMICAL IND. CO., LTD.) was added as the foaming agent (V) in an amount, in terms of an outside amount, of 4 to 6 parts by mass with respect to 100 parts by mass of the hydrogenated block copolymer composition, and the resultant was dry-blended.

The thus obtained dry-blended product of the pellet of the hydrogenated block copolymer composition and the foaming agent was molded with an injection molding machine having a core back function (MD450S manufactured by UBE MACHINERY CORPORATION, Ltd.) into a shape of a flat plate of 30×40 cm. One surface of the flat plate was processed into a leather-textured surface.

Injection molding of the thus obtained molded product was performed, by the full shot method, in a mold with a thickness of 0.5 to 3.5 mm at a nozzle temperature of 220° C. and a mold temperature of 40° C. in a fixed portion and of 35° C. in a movable portion, and an injection speed of 100 mm/s, and then, the mold core back was performed at 480 mm/s for causing foaming at a prescribed foaming ratio. After cooling the resultant for 20 seconds, an objective foam body was molded. The resultant foam body had a structure including a non-foam skin layer, a foam core layer, and another non-foam skin layer adjacent to each other in the stated order.

The physical properties of the hydrogenated block copolymers (I) are shown in Tables 1 and 2, and the physical properties of the hydrogenated block copolymer compositions, the physical properties of the foam bodies, and the results of the property evaluation are shown in Tables 3 to 12 below.

TABLE 1

| | Pro. | Pro. | Pro. | Pro. | Pro. | Pro. | Pro. | Pro. | Pro. |
|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 |
| Hydrogenated Block Copolymer | (I)-1 | (I)-2 | (I)-3 | (I)-4 | (I)-5 | (I)-6 | (I)-7 | (I)-8 | (I)-9 |
| Content of All Vinyl Aromatic Monomer Units (mass %) | 71 | 82 | 58 | 45 | 41 | 34 | 40 | 66 | 65 |
| Content of Polymer Block (a) (mass %) | 30 | 30 | 30 | 30 | 30 | 30 | 30 | 16 | 14 |
| Content of Hydrogenated Copolymer Block (b) (mass %) | 70 | 70 | 70 | 70 | 70 | 70 | 70 | 84 | 86 |
| Content of Vinyl Aromatic Monomer Unit in Hydrogenated | 59 | 74 | 40 | 21 | 16 | 5 | 14 | 59 | 59 |
| Copolymer Block (b) (mass %) | | | | | | | | | |
| Content of Vinyl Aromatic Monomer Unit in Hydrogenated | 41 | 52 | 28 | 15 | 11 | 4 | 10 | 50 | 51 |
| Copolymer Block (b) in Entire Polymer (mass %) | | | | | | | | | |
| Content of Conjugated Diene in Hydrogenated Copolymer | 29 | 18 | 42 | 55 | 59 | 67 | 60 | 34 | 35 |
| Block (b) in Entire Polymer (mass %) | | | | | | | | | |
| Vinyl Bond Content in Hydrogenated Block Copolymer (I) | 46 | 15 | 48 | 60 | 70 | 75 | 70 | 46 | 46 |
| (mass %) | | | | | | | | | |
| Hydrogenation Rate of Double Bond in Conjugated Diene | 98 | 99 | 98 | 97 | 98 | 98 | 99 | 98 | 96 |
| Monomer Unit (%) | | | | | | | | | |
| MFR(230° C., 2.16 kg) | 101 | 100 | 102 | 103 | 101 | 101 | 101 | 103 | 100 |
| Hardness (JIS-A,15s) | 84 | — | 80 | 73 | 69 | 66 | 69 | 56 | 53 |
| Hardness (JIS-D,15s) | — | 49 | — | — | — | — | — | — | — |

TABLE 2

| | Pro. | Pro. | Pro. | Pro. | Pro. | Pro. | Pro. |
|---|---|---|---|---|---|---|---|
| | Ex. 10 | Ex. 11 | Ex. 12 | Ex. 13 | Ex. 14 | Ex. 15 | Ex. 16 |
| Hydrogenated Block Copolymer | (I)-10 | (I)-11 | (I)-12 | (I)-13 | (I)-A | (I)-B | (I)-C |
| Content of All Vinyl Aromatic Monomer Units (mass %) | 64 | 15 | 71 | 71 | 32 | 63 | 33 |
| Content of Polymer Block (a) (mass %) | 11 | 11 | 30 | 30 | 30 | 9 | 15 |
| Content of Hydrogenated Copolymer Block (b) (mass %) | 89 | 89 | 70 | 70 | 70 | 91 | 85 |
| Content of Vinyl Aromatic Monomer Unit in Hydrogenated | 59 | 5 | 59 | 59 | 3 | 59 | 21 |
| Copolymer Block (b) (mass %) | | | | | | | |
| Content of Vinyl Aromatic Monomer Unit in Hydrogenated | 53 | 4 | 41 | 41 | 2 | 54 | 18 |
| Copolymer Block (b) in Entire Polymer (mass %) | | | | | | | |
| Content of Conjugated Diene in Hydrogenated Copolymer | 36 | 85 | 29 | 29 | 68 | 37 | 67 |
| Block (b) in Entire Polymer (mass %) | | | | | | | |
| Vinyl Bond Content in Hydrogenated Block Copolymer (I) | 46 | 75 | 46 | 46 | 76 | 46 | 77 |
| (mass %) | | | | | | | |
| Hydrogenation Rate of Double Bond in Conjugated Diene | 98 | 98 | 99 | 98 | 99 | 98 | 98 |
| Monomer Unit (%) | | | | | | | |
| MFR(230° C., 2.16 kg) | 102 | 102 | 25 | 15 | 100 | 101 | 50 |
| Hardness (JIS-A, 15s) | 49 | 40 | 84 | 84 | 65 | 47 | 45 |
| Hardness (JIS-D, 15s) | — | — | — | — | — | — | — |

TABLE 3

| | Parts by Mass | Ex. 1 | \|Ex. 2 | Ex. 3 | Ex. 4 | Ex. 5 |
|---|---|---|---|---|---|---|
| Hydrogenated | Hydrogenated Block Copolymer (I)-1 | 40 | | | | |
| Block | Hydrogenated Block Copolymer (I)-2 | | 40 | | | |
| Copolymer | Hydrogenated Block Copolymer (I)-3 | | | 40 | | |
| Composition | Hydrogenated Block Copolymer (I)-4 | | | | 40 | |
| (parts by mass) | Hydrogenated Block Copolymer (I)-5 | | | | | 40 |
| | Hydrogenated Block Copolymer (I)-6 | | | | | |
| | Hydrogenated Block Copolymer (I)-7 | | | | | |
| | Hydrogenated Block Copolymer (I)-8 | | | | | |
| | Hydrogenated Block Copolymer (I)-9 | | | | | |
| | Hydrogenated Block Copolymer (I)-10 | | | | | |
| | Hydrogenated Block Copolymer (I)-11 | | | | | |
| | Hydrogenated Block Copolymer (I)-12 | | | | | |
| | Hydrogenated Block Copolymer (I)-13 | | | | | |
| | Hydrogenated Block Copolymer (I)-A | | | | | |
| | Hydrogenated Block Copolymer (I)-B | | | | | |
| | Hydrogenated Block Copolymer (I)-C | | | | | |
| | Olefin-based Resin (II)-1 | 18 | 18 | 18 | 18 | 18 |
| | Olefin-based Resin (II)-2 | | | | | |
| | Olefin-based Resin (II)-3 | | | | | |
| | Thermoplastic Resin (III)-1 | 14 | 14 | 14 | 14 | 14 |
| | Thermoplastic Resin (III)-2 | | | | | |
| | Softener (IV) | 28 | 28 | 28 | 28 | 28 |
| Physical | MFR(230° C., 2.16 kg) | 150 | 150 | 140 | 140 | 130 |
| Properties of | Hardness (JIS-A,15s) | 68 | 72 | 67 | 67 | 66 |
| Hydrogenated | | | | | | |
| Block | | | | | | |
| Copolymer | | | | | | |
| Composition | | | | | | |
| Foaming Agent (V) Polythrene EE25-C (phr VS | | 6 | 6 | 6 | 6 | 6 |
| Hydrogenated Block Copolymer Composition) | | | | | | |
| Physical | Foaming Ratio | 1.75 | 1.75 | 1.75 | 1.75 | 1.75 |
| Properties of | Entire Thickness of Foam Body (μm) | 4000 | 4000 | 4000 | 4000 | 4000 |
| Foaming Body, | Thickness of Non-foam Skin Layer (μm) | 300 | 300 | 300 | 300 | 300 |
| Properties | Thickness of Foam Core Layer (μm) | 3400 | 3400 | 3400 | 3400 | 3400 |
| | Score of Wear Resistance on Foam Body | 4 | 4 | 4 | 4 | 4 |
| | Surface | | | | | |
| | Score of Surface Appearance of Foam | 3 | 3 | 3 | 3 | 3 |
| | Body | | | | | |
| | Score of Cushioning Property of Foam | 5 | 5 | 5 | 5 | 5 |
| | Body | | | | | |

TABLE 4

| | Parts by Mass | Ex. 6 | Ex. 7 | Ex. 8 | Ex. 9 | Ex. 10 |
|---|---|---|---|---|---|---|
| Hydrogenated | Hydrogenated Block Copolymer (I)-1 | | | | | |
| Block | Hydrogenated Block Copolymer (I)-2 | | | | | |
| Copolymer | Hydrogenated Block Copolymer (I)-3 | | | | | |
| Composition | Hydrogenated Block Copolymer (I)-4 | | | | | |
| (parts by mass | Hydrogenated Block Copolymer (I)-5 | | | | | |
| | Hydrogenated Block Copolymer (I)-6 | 40 | | | | |
| | Hydrogenated Block Copolymer (I)-7 | | 40 | | | |
| | Hydrogenated Block Copolymer (I)-8 | | | 40 | | |
| | Hydrogenated Block Copolymer (I)-9 | | | | 40 | |
| | Hydrogenated Block Copolymer (I)-10 | | | | | 40 |
| | Hydrogenated Block Copolymer (I)-11 | | | | | |
| | Hydrogenated Block Copolymer (I)-12 | | | | | |
| | Hydrogenated Block Copolymer (I)-13 | | | | | |
| | Hydrogenated Block Copolymer (I)-A | | | | | |
| | Hydrogenated Block Copolymer (I)-B | | | | | |
| | Hydrogenated Block Copolymer (I)-C | | | | | |
| | Olefin-based Resin (II)-1 | 18 | 18 | 18 | 18 | 18 |
| | Olefin-based Resin (II)-2 | | | | | |
| | Olefin-based Resin (II)-3 | | | | | |
| | Thermoplastic Resin (III)-1 | 14 | 14 | 14 | 14 | 14 |
| | Thermoplastic Resin (III)-2 | | | | | |
| | Softener (IV) | 28 | 28 | 28 | 28 | 28 |
| Physical | MFR(230° C., 2.16 kg) | 130 | 130 | 130 | 130 | 130 |
| Properties of | Hardness (JIS-A, 15s) | 66 | 66 | 63 | 63 | 61 |
| Hydrogenated | | | | | | |
| Block | | | | | | |
| Copolymer | | | | | | |
| Composition | | | | | | |
| Foaming Agent (V) Polythrene EE25-C (phr VS | | 6 | 6 | 6 | 6 | 6 |
| Hydrogenated Block Copolymer Composition) | | | | | | |
| Physical | Foaming Ratio | 1.75 | 1.75 | 1.75 | 1.75 | 1.75 |
| Properties of | Entire Thickness of Foam Body (μm) | 4000 | 4000 | 4000 | 4000 | 4000 |
| Foaming | Thickness of Non-foam Skin Layer (μm) | 300 | 300 | 300 | 300 | 300 |
| Body, | Thickness of Foam Core Layer (μm) | 3400 | 3400 | 3400 | 3400 | 3400 |
| Properties | Score of Wear Resistance on Foam | 3 | 3 | 4 | 3 | 3 |
| | Body Surface | | | | | |
| | Score of Surface Appearance of Foam | 3 | 3 | 3 | 3 | 3 |
| | Body | | | | | |
| | Score of Cushioning Property of Foam | 5 | 5 | 5 | 5 | 5 |
| | Body | | | | | |

TABLE 5

| | Parts by Mass | Ex. 11 | Ex. 12 | Ex. 13 | Ex. 14 | Ex. 15 |
|---|---|---|---|---|---|---|
| Hydrogenated | Hydrogenated Block Copolymer (I)-1 | | 40 | | | 40 |
| Block | Hydrogenated Block Copolymer (I)-2 | | | | | |
| Copolymer | Hydrogenated Block Copolymer (I)-3 | | | | | |
| Composition | Hydrogenated Block Copolymer (I)-4 | | | | | |
| (parts by | Hydrogenated Block Copolymer (I)-5 | | | | | |
| mass) | Hydrogenated Block Copolymer (I)-6 | | | | | |
| | Hydrogenated Block Copolymer (I)-7 | | | | | |
| | Hydrogenated Block Copolymer (I)-8 | | | | | |
| | Hydrogenated Block Copolymer (I)-9 | | | | | |
| | Hydrogenated Block Copolymer (I)-10 | | | | | |
| | Hydrogenated Block Copolymer (I)-11 | 40 | | | | |
| | Hydrogenated Block Copolymer (I)-12 | | | 40 | | |
| | Hydrogenated Block Copolymer (I)-13 | | | | 40 | |
| | Hydrogenated Block Copolymer (I)-A | | | | | |
| | Hydrogenated Block Copolymer (I)-B | | | | | |
| | Hydrogenated Block Copolymer (I)-C | | | | | |
| | Olefin-based Resin (II)-1 | 18 | | 18 | 18 | 12 |
| | Olefin-based Resin (II)-2 | | 18 | | | |
| | Olefin-based Resin (II)-3 | | | | | |
| | Thermoplastic Resin (III)-1 | 14 | 14 | 14 | 14 | 16 |
| | Thermoplastic Resin (III)-2 | | | | | |
| | Softener (IV) | 28 | 28 | 28 | 28 | 32 |
| Physical | MFR(230° C., 2.16 kg) | 130 | 95 | 80 | 65 | 190 |
| Properties of | Hardness (JIS-A,15s) | 59 | 69 | 68 | 68 | 56 |
| Hydrogenated | | | | | | |
| Block | | | | | | |
| Copolymer | | | | | | |
| Composition | | | | | | |
| Foaming Agent (V) Polythrene EE25-C (phr VS | | 6 | 6 | 6 | 6 | 6 |
| Hydrogenated Block Copolymer Composition) | | | | | | |
| Physical | Foaming Ratio | 1.75 | 1.75 | 1.75 | 1.75 | 1.75 |
| Properties of | Entire Thickness of Foam Body (μm) | 4000 | 4000 | 4000 | 4000 | 4000 |
| Foaming | Thickness of Non-foam Skin Layer (μm) | 300 | 300 | 300 | 300 | 300 |
| Body, | Thickness of Foam Core Layer (μm) | 3400 | 3400 | 3400 | 3400 | 3400 |
| Properties | Score of Wear Resistance on Foam | 2 | 4 | 4 | 4 | 4 |
| | Body Surface | | | | | |
| | Score of Surface Appearance of Foam | 3 | 2 | 2 | 2 | 3 |
| | Body | | | | | |
| | Score of Cushioning Property of Foam | 5 | 5 | 5 | 5 | 5 |
| | Body | | | | | |

TABLE 6

| | Parts by Mass | Ex. 16 | Ex. 17 | Ex. 18 | Ex. 19 |
|---|---|---|---|---|---|
| Hydrogenated | Hydrogenated Block Copolymer (I)-1 | 40 | 40 | 40 | 40 |
| Block Copolymer | Hydrogenated Block Copolymer (I)-2 | | | | |
| Composition | Hydrogenated Block Copolymer (I)-3 | | | | |
| (parts by mass) | Hydrogenated Block Copolymer (I)-4 | | | | |
| | Hydrogenated Block Copolymer (I)-5 | | | | |
| | Hydrogenated Block Copolymer (I)-6 | | | | |
| | Hydrogenated Block Copolymer (I)-7 | | | | |
| | Hydrogenated Block Copolymer (I)-8 | | | | |
| | Hydrogenated Block Copolymer (I)-9 | | | | |
| | Hydrogenated Block Copolymer (I)-10 | | | | |
| | Hydrogenated Block Copolymer (I)-11 | | | | |
| | Hydrogenated Block Copolymer (I)-12 | | | | |
| | Hydrogenated Block Copolymer (I)-13 | | | | |
| | Hydrogenated Block Copolymer (I)-A | | | | |
| | Hydrogenated Block Copolymer (I)-B | | | | |
| | Hydrogenated Block Copolymer (I)-C | | | | |
| | Olefin-based Resin (II)-1 | 15 | 21 | 24 | 26 |
| | Olefin-based Resin (II)-2 | | | | |
| | Olefin-based Resin (II)-3 | | | | |
| | Thermoplastic Resin (III)-1 | 15 | 13 | 12 | 11 |
| | Thermoplastic Resin (III)-2 | | | | |
| | Softener (IV) | 30 | 26 | 24 | 23 |
| Physical | MFR(230° C., 2.16 kg) | 180 | 140 | 120 | 110 |
| Properties of | Hardness (JIS-A,15s) | 61 | 74 | 79 | 84 |
| Hydrogenated | | | | | |
| Block Copolymer | | | | | |
| Composition | | | | | |
| Foaming Agent (V) Polythrene EE25-C (phr VS | | 6 | 6 | 6 | 6 |
| Hydrogenated Block Copolymer Composition) | | | | | |
| Physical | Foaming Ratio | 1.75 | 1.75 | 1.75 | 1.75 |
| Properties of | Entire Thickness of Foam Body (μm) | 4000 | 4000 | 4000 | 4000 |
| Foaming Body, | Thickness of Non-foam Skin Layer (μm) | 300 | 300 | 300 | 300 |
| Properties | Thickness of Foam Core Layer (μm) | 3400 | 3400 | 3400 | 3400 |
| | Score of Wear Resistance on Foam | 4 | 4 | 4 | 4 |
| | Body Surface | | | | |
| | Score of Surface Appearance of Foam | 3 | 3 | 3 | 3 |
| | Body | | | | |
| | Score of Cushioning Property of Foam | 5 | 5 | 4 | 4 |
| | Body | | | | |

TABLE 7

| | Parts by Mass | Ex. 20 | Ex. 21 | Ex. 22 | Ex. 23 | Ex. 24 |
|---|---|---|---|---|---|---|
| Hydrogenated | Hydrogenated Block Copolymer (I)-1 | 50 | 30 | 20 | 10 | 40 |
| Block | Hydrogenated Block Copolymer (I)-2 | | | | | |
| Copolymer | Hydrogenated Block Copolymer (I)-3 | | | | | |
| Composition | Hydrogenated Block Copolymer (I)-4 | | | | | |
| (parts by | Hydrogenated Block Copolymer (I)-5 | | | | | |
| mass) | Hydrogenated Block Copolymer (I)-6 | | | | | |
| | Hydrogenated Block Copolymer (I)-7 | | | | | |
| | Hydrogenated Block Copolymer (I)-8 | | | | | |
| | Hydrogenated Block Copolymer (I)-9 | | | | | |
| | Hydrogenated Block Copolymer (I)-10 | | | | | |
| | Hydrogenated Block Copolymer (I)-11 | | | | | |
| | Hydrogenated Block Copolymer (I)-12 | | | | | |
| | Hydrogenated Block Copolymer (I)-13 | | | | | |
| | Hydrogenated Block Copolymer (I)-A | | | | | |
| | Hydrogenated Block Copolymer (I)-B | | | | | |
| | Hydrogenated Block Copolymer (I)-C | | | | | |
| | Olefin-based Resin (II)-1 | 16 | 20 | 23 | 26 | |
| | Olefin-based Resin (II)-2 | | | | | |
| | Olefin-based Resin (II)-3 | | | | | 18 |
| | Thermoplastic Resin (III)-1 | 14 | 17 | 19 | 22 | 21 |
| | Thermoplastic Resin (III)-2 | | | | | |
| | Softener (IV) | 28 | 33 | 38 | 42 | 21 |
| Physical | MFR(230° C., 2.16 kg) | 150 | 140 | 130 | 120 | 120 |
| Properties of | Hardness (JIS-A,15s) | 68 | 69 | 72 | 74 | 74 |
| Hydrogenated | | | | | | |
| Block | | | | | | |
| Copolymer | | | | | | |
| Composition | | | | | | |
| Foaming Agent (V) Polythrene EE25-C (phr VS | | 6 | 6 | 6 | 6 | 6 |
| Hydrogenated Block Copolymer Composition) | | | | | | |
| Physical | Foaming Ratio | 1.75 | 1.75 | 1.75 | 1.75 | 1.75 |
| Properties of | Entire Thickness of Foam Body (μm) | 4000 | 4000 | 4000 | 4000 | 4000 |
| Foaming | Thickness of Non-foam Skin Layer (μm) | 300 | 300 | 300 | 300 | 300 |
| Body, | Thickness of Foam Core Layer (μm) | 3400 | 3400 | 3400 | 3400 | 3400 |
| Properties | Score of Wear Resistance on Foam | 4 | 4 | 4 | 4 | 4 |
| | Body Surface | | | | | |
| | Score of Surface Appearance of Foam | 3 | 3 | 3 | 3 | 3 |
| | Body | | | | | |
| | Score of Cushioning Property of | 5 | 5 | 5 | 5 | 5 |
| | Foam Body | | | | | |

TABLE 8

| | Parts by Mass | Ex. 25 | Ex. 26 | Ex. 27 | Ex. 28 | Ex. 29 |
|---|---|---|---|---|---|---|
| Hydrogenated | Hydrogenated Block Copolymer (I)-1 | 40 | 40 | 40 | 40 | 40 |
| Block | Hydrogenated Block Copolymer (I)-2 | | | | | |
| Copolymer | Hydrogenated Block Copolymer (I)-3 | | | | | |
| Composition | Hydrogenated Block Copolymer (I)-4 | | | | | |
| (parts by | Hydrogenated Block Copolymer (I)-5 | | | | | |
| mass) | Hydrogenated Block Copolymer (I)-6 | | | | | |
| | Hydrogenated Block Copolymer (I)-7 | | | | | |
| | Hydrogenated Block Copolymer (I)-8 | | | | | |
| | Hydrogenated Block Copolymer (I)-9 | | | | | |
| | Hydrogenated Block Copolymer (I)-10 | | | | | |
| | Hydrogenated Block Copolymer (I)-11 | | | | | |
| | Hydrogenated Block Copolymer (I)-12 | | | | | |
| | Hydrogenated Block Copolymer (I)-13 | | | | | |
| | Hydrogenated Block Copolymer (I)-A | | | | | |
| | Hydrogenated Block Copolymer (I)-B | | | | | |
| | Hydrogenated Block Copolymer (I)-C | | | | | |
| | Olefin-based Resin (II)-1 | 18 | 18 | 18 | 18 | 18 |
| | Olefin-based Resin (II)-2 | | | | | |
| | Olefin-based Resin (II)-3 | | | | | |
| | Thermoplastic Resin (III)-1 | 11 | 14 | 14 | 14 | 14 |
| | Thermoplastic Resin (III)-2 | | | | | |
| | Softener (IV) | 31 | 28 | 28 | 28 | 28 |
| Physical | MFR(230° C., 2.16 kg) | 200 | 150 | 150 | 150 | 150 |
| Properties of | Hardness (JIS-A,15s) | 67 | 68 | 68 | 68 | 68 |
| Hydrogenated | | | | | | |
| Block | | | | | | |
| Copolymer | | | | | | |
| Composition | | | | | | |
| Foaming Agent (V) Polythrene EE25-C (phr VS | | 6 | 6 | 6 | 6 | 4 |
| Hydrogenated Block Copolymer Composition) | | | | | | |
| Physical | Foaming Ratio | 1.75 | 1.3 | 1.5 | 2 | 1.75 |
| Properties of | Entire Thickness of Foam Body (μm) | 4000 | 4000 | 4000 | 4000 | 4000 |
| Foaming | Thickness of Non-foam Skin Layer (μm) | 300 | 300 | 300 | 300 | 300 |
| Body, | Thickness of Foam Core Layer (μm) | 3400 | 3400 | 3400 | 3400 | 3400 |
| Properties | Score of Wear Resistance on Foam | 4 | 4 | 4 | 4 | 4 |
| | Body Surface | | | | | |
| | Score of Surface Appearance of Foam | 3 | 3 | 3 | 3 | 3 |
| | Body | | | | | |
| | Score of Cushioning Property of Foam | 5 | 4 | 5 | 5 | 5 |
| | Body | | | | | |

TABLE 9

| | Parts by Mass | Ex. 30 | Ex. 31 | Ex. 32 | Ex. 33 |
|---|---|---|---|---|---|
| Hydrogenated | Hydrogenated Block Copolymer (I)-1 | 40 | 40 | 40 | 40 |
| Block | Hydrogenated Block Copolymer (I)-2 | | | | |
| Copolymer | Hydrogenated Block Copolymer (I)-3 | | | | |
| Composition | Hydrogenated Block Copolymer (I)-4 | | | | |
| (parts | Hydrogenated Block Copolymer (I)-5 | | | | |
| by mass) | Hydrogenated Block Copolymer (I)-6 | | | | |
| | Hydrogenated Block Copolymer (I)-7 | | | | |
| | Hydrogenated Block Copolymer (I)-8 | | | | |
| | Hydrogenated Block Copolymer (I)-9 | | | | |
| | Hydrogenated Block Copolymer (I)-10 | | | | |
| | Hydrogenated Block Copolymer (I)-11 | | | | |
| | Hydrogenated Block Copolymer (I)-12 | | | | |
| | Hydrogenated Block Copolymer (I)-13 | | | | |
| | Hydrogenated Block Copolymer (I)-A | | | | |
| | Hydrogenated Block Copolymer (I)-B | | | | |
| | Hydrogenated Block Copolymer (I)-C | | | | |
| | Olefin-based Resin (II)-1 | 12 | 18 | 18 | 18 |
| | Olefin-based Resin (II)-2 | | | | |
| | Olefin-based Resin (II)-3 | | | | |
| | Thermoplastic Resin (III)-1 | 16 | 14 | 14 | 14 |
| | Thermoplastic Resin (III)-2 | | | | |
| | Softener (IV) | 32 | 28 | 28 | 28 |
| Physical | MFR(230° C., 2.16 kg) | 190 | 150 | 150 | 150 |
| Properties of | Hardness (JIS-A, 15 s) | 55 | 68 | 68 | 68 |
| Hydrogenated | | | | | |
| Block | | | | | |
| Copolymer | | | | | |
| Composition | | | | | |
| Foaming Agent (V) Polythrene EE25-C (phr VS | | 6 | 6 | 6 | 6 |
| Hydrogenated Block Copolymer Composition) | | | | | |
| Physical | Foaming Ratio | 1.3 | 1.75 | 1.75 | 1.75 |
| Properties | Entire Thickness of Foam Body (μm) | 4000 | 4000 | 4000 | 1700 |
| of Foaming | Thickness of Non-foam Skin Layer (μm) | 300 | 400 | 600 | 300 |
| Body, | Thickness of Foam Core Layer (μm) | 3400 | 3200 | 2800 | 1100 |
| Properties | Score of Wear Resistance on | 4 | 4 | 4 | 4 |
| | Foam Body Surface | | | | |
| | Score of Surface Appearance | 3 | 3 | 3 | 3 |
| | of Foam Body | | | | |
| | Score of Cushioning Property | 4 | 5 | 4 | 5 |
| | of Foam Body | | | | |

TABLE 10

| | Parts by Mass | Ex. 34 | Ex. 35 | Ex. 36 |
|---|---|---|---|---|
| Hydrogenated | Hydrogenated Block Copolymer (I)-1 | 40 | 40 | 40 |
| Block | Hydrogenated Block Copolymer (I)-2 | | | |
| Copolymer | Hydrogenated Block Copolymer (I)-3 | | | |
| Composition | Hydrogenated Block Copolymer (I)-4 | | | |
| (parts | Hydrogenated Block Copolymer (I)-5 | | | |
| by mass) | Hydrogenated Block Copolymer (I)-6 | | | |
| | Hydrogenated Block Copolymer (I)-7 | | | |
| | Hydrogenated Block Copolymer (I)-8 | | | |
| | Hydrogenated Block Copolymer (I)-9 | | | |
| | Hydrogenated Block Copolymer (I)-10 | | | |
| | Hydrogenated Block Copolymer (I)-11 | | | |
| | Hydrogenated Block Copolymer (I)-12 | | | |
| | Hydrogenated Block Copolymer (I)-13 | | | |
| | Hydrogenated Block Copolymer (I)-A | | | |
| | Hydrogenated Block Copolymer (I)-B | | | |
| | Hydrogenated Block Copolymer (I)-C | | | |
| | Olefin-based Resin (II)-1 | 18 | 18 | 24 |
| | Olefin-based Resin (II)-2 | | | |
| | Olefin-based Resin (II)-3 | | | |
| | Thermoplastic Resin (III)-1 | 14 | 14 | 12 |
| | Thermoplastic Resin (III)-2 | | | |
| | Softener (IV) | 28 | 28 | 24 |
| Physical | MFR(230° C., 2.16 kg) | 150 | 150 | 120 |
| Properties of | Hardness (JIS-A, 15 s) | 68 | 68 | 79 |
| Hydrogenated | | | | |
| Block | | | | |
| Copolymer | | | | |
| Composition | | | | |
| Foaming Agent (V) Polythrene EE25-C (phr VS | | 6 | 6 | 6 |
| Hydrogenated Block Copolymer Composition) | | | | |
| Physical | Foaming Ratio | 1.75 | 1.75 | 1.3 |
| Properties | Entire Thickness of Foam Body (μm) | 1500 | 1000 | 2100 |
| of Foaming | Thickness of Non-foam Skin Layer (μm) | 300 | 300 | 600 |
| Body, | Thickness of Foam Core Layer (μm) | 900 | 400 | 900 |
| Properties | Score of Wear Resistance on | 4 | 4 | 4 |
| | Foam Body Surface | | | |
| | Score of Surface Appearance | 3 | 3 | 3 |
| | of Foam Body | | | |
| | Score of Cushioning Property | 4 | 4 | 2 |
| | of Foam Body | | | |

TABLE 11

| | | Com. | Com. | Com. |
|---|---|---|---|---|
| | Parts by Mass | Ex. 1 | Ex. 2 | Ex. 3 |
| Hydrogenated | Hydrogenated Block Copolymer (I)-1 | | | 40 |
| Block | Hydrogenated Block Copolymer (I)-2 | | | |
| Copolymer | Hydrogenated Block Copolymer (I)-3 | | | |
| Composition | Hydrogenated Block Copolymer (I)-4 | | | |
| (parts | Hydrogenated Block Copolymer (I)-5 | | | |
| by mass) | Hydrogenated Block Copolymer (I)-6 | | | |
| | Hydrogenated Block Copolymer (I)-7 | | | |
| | Hydrogenated Block Copolymer (I)-8 | | | |
| | Hydrogenated Block Copolymer (I)-9 | | | |
| | Hydrogenated Block Copolymer (I)-10 | | | |
| | Hydrogenated Block Copolymer (I)-11 | | | |
| | Hydrogenated Block Copolymer (I)-12 | | | |
| | Hydrogenated Block Copolymer (I)-13 | | | |
| | Hydrogenated Block Copolymer (I)-A | 40 | | |
| | Hydrogenated Block Copolymer (I)-B | | 40 | |
| | Hydrogenated Block Copolymer (I)-C | | | |
| | Olefin-based Resin (II)-1 | 18 | 18 | 28 |
| | Olefin-based Resin (II)-2 | | | |
| | Olefin-based Resin (II)-3 | | | |
| | Thermoplastic Resin (III)-1 | 14 | 14 | 11 |
| | Thermoplastic Resin (III)-2 | | | |
| | Softener (IV) | 28 | 28 | 21 |
| Physical | MFR(230° C., 2.16 kg) | 150 | 130 | 110 |
| Properties of | Hardness (JIS-A, 15 s) | 65 | 61 | 87 |
| Hydrogenated | | | | |
| Block | | | | |
| Copolymer | | | | |
| Composition | | | | |
| Foaming Agent (V) Polythrene EE25-C (phr VS | | 6 | 6 | 6 |
| Hydrogenated Block Copolymer Composition) | | | | |
| Physical | Foaming Ratio | 1.75 | 1.75 | 1.75 |
| Properties | Entire Thickness of Foam Body (μm) | 4000 | 4000 | 4000 |
| of Foaming | Thickness of Non-foam Skin Layer (μm) | 300 | 300 | 300 |
| Body, | Thickness of Foam Core Layer (μm) | 3400 | 3400 | 3400 |
| Properties | Score of Wear Resistance on | 1 | 1 | 4 |
| | Foam Body Surface | | | |
| | Score of Surface Appearance | 3 | 3 | 3 |
| | of Foam Body | | | |
| | Score of Cushioning Property | 5 | 5 | 1 |
| | of Foam Body | | | |

TABLE 12

| | | Com. | Com. | Com. | Com. |
|---|---|---|---|---|---|
| | Parts by Mass | Ex. 4 | Ex. 5 | Ex. 6 | Ex. 7 |
| Hydrogenated | Hydrogenated Block Copolymer (I)-1 | 0 | 40 | | 40 |
| Block | Hydrogenated Block Copolymer (I)-2 | | | | |
| Copolymer | Hydrogenated Block Copolymer (I)-3 | | | | |
| Composition | Hydrogenated Block Copolymer (I)-4 | | | | |
| (parts | Hydrogenated Block Copolymer (I)-5 | | | | |
| by mass) | Hydrogenated Block Copolymer (I)-6 | | | | |
| | Hydrogenated Block Copolymer (I)-7 | | | | |
| | Hydrogenated Block Copolymer (I)-8 | | | | |
| | Hydrogenated Block Copolymer (I)-9 | | | | |
| | Hydrogenated Block Copolymer (I)-10 | | | | |
| | Hydrogenated Block Copolymer (I)-11 | | | | |
| | Hydrogenated Block Copolymer (I)-12 | | | | |
| | Hydrogenated Block Copolymer (I)-13 | | | | |
| | Hydrogenated Block Copolymer (I)-A | | | | |
| | Hydrogenated Block Copolymer (I)-B | | | | |
| | Hydrogenated Block Copolymer (I)-C | | | 39 | |
| | Olefin-based Resin (II)-1 | 27 | 12 | | 18 |
| | Olefin-based Resin (II)-2 | | | 22 | |
| | Olefin-based Resin (II)-3 | | | | |
| | Thermoplastic Resin (III)-1 | 24 | 16 | | 14 |
| | Thermoplastic Resin (III)-2 | | | 26 | |
| | Softener (IV) | 49 | 32 | 13 | 28 |
| Physical | MFR(230° C., 2.16 kg) | 110 | 190 | 20 | 150 |
| Properties of | Hardness (JIS-A, 15 s) | 75 | 56 | 74 | 68 |
| Hydrogenated | | | | | |
| Block | | | | | |
| Copolymer | | | | | |
| Composition | | | | | |
| Foaming Agent (V) Polythrene EE25-C (phr VS | | 6 | 6 | 6 | 6 |
| Hydrogenated Block Copolymer Composition) | | | | | |
| Physical | Foaming Ratio | 1.75 | 1.15 | 1.75 | 1.75 |
| Properties | Entire Thickness of Foam Body (μm) | 4000 | 4000 | 4000 | 850 |
| of Foaming | Thickness of Non-foam Skin Layer (μm) | 300 | 300 | 300 | 300 |
| Body, | Thickness of Foam Core Layer (μm) | 3400 | 3400 | 3400 | 250 |
| Properties | Score of Wear Resistance on | 1 | 4 | 4 | 4 |
| | Foam Body Surface | | | | |
| | Score of Surface Appearance | 3 | 3 | 1 | 3 |
| | of Foam Body | | | | |
| | Score of Cushioning Property | 5 | 1 | 5 | 1 |
| | of Foam Body | | | | |

It was thus found that the foam body of the present invention is good in the molded appearance, the cushioning property, and the wear resistance, and is excellent also in balance among these properties.

### [Production of Laminate]

### Example 37

A 1.8 mm PP (polypropylene) substrate was injection molded at a nozzle temperature of 220° C. and a mold temperature of 40° C. Thereafter, in the same manner as described above, the hydrogenated block copolymer composition (I)-1 was laminated thereon by the core back foam molding by the two-color molding method, and thus, a laminate in which a foam body of the hydrogenated block copolymer composition was laminated on the PP substrate was obtained.

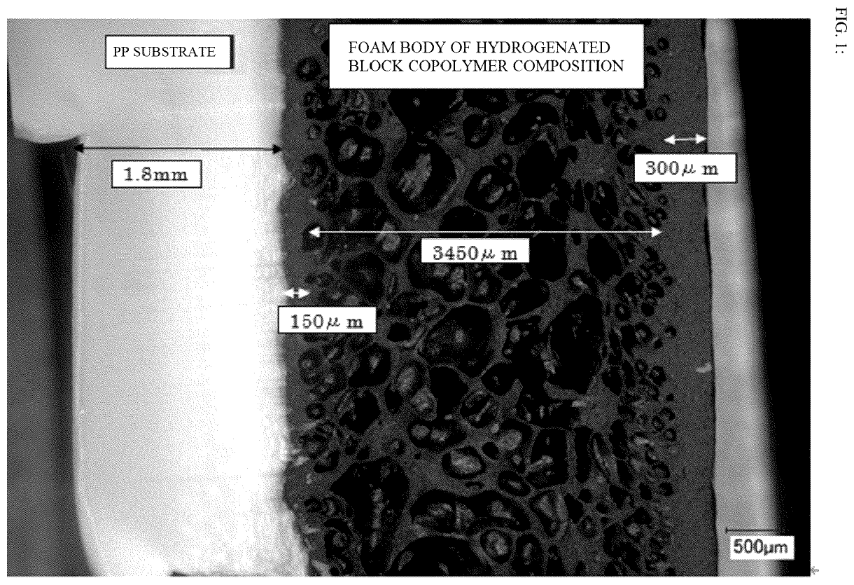

FIG. 1 is a cross-sectional view of the laminate.

The layer of the foam body containing the hydrogenated block copolymer composition had a thickness, before foaming, of 2 mm, and a thickness, after foaming, of 3.9 mm, the non-foam skin layer not in contact with the PP substrate had a thickness of 300 μm, the non-foam skin layer in contact with the PP substrate had a thickness of 150 μm, and the foam core layer had a thickness of 3,450 μm.

It was found that the thus obtained laminate is good in the molded appearance, the wear resistance, and the cushioning property, and has good rigidity.

### INDUSTRIAL APPLICABILITY

A foam body according to the present invention is industrially applicable in the fields of vehicle components (vehicle interior materials and vehicle exterior materials), materials of medical instruments, various containers including food packaging containers, home appliances, industrial components, toys and the like.

1. A foam body of a hydrogenated block copolymer composition, comprising:
a hydrogenated block copolymer (I);
an olefin-based resin (II);
a thermoplastic resin (III); and
a softener (IV),
wherein the foam body comprises a foam core layer and a non-foam skin layer adjacent to each other,
the foam core layer has a thickness of 300 μm or more,
the foam body has a foaming ratio of 1.2-fold or more, and
the foam body satisfies the following conditions (1) to (5):
<Condition (1)>
the hydrogenated block copolymer (I) is a hydrogenated product of a block copolymer containing a vinyl aromatic monomer unit, and a conjugated monomer unit;
<Condition (2)>
the hydrogenated block copolymer (I) contains at least one polymer block (a) principally containing a vinyl aromatic monomer unit, and a content of the polymer block (a) principally containing a vinyl aromatic monomer unit in the hydrogenated block copolymer (I) is 10% by mass or more and 40% by mass or less;
<Condition (3)>
the hydrogenated block copolymer (I) contains at least one hydrogenated copolymer block (b) containing a vinyl aromatic monomer unit, and a conjugated diene monomer unit, and a content of the vinyl aromatic monomer unit in the hydrogenated copolymer block (b) is 5% by mass or more and 79% by mass or less;
<Condition (4)>
the hydrogenated block copolymer composition has a value of 15 seconds hardness measured with a type A durometer in accordance with JIS K6253 of 85 or less; and
<Condition (5)>
the hydrogenated block copolymer composition has an MFR value measured under conditions of a temperature of 230° C. and a load of 2.16 kg in accordance with JIS K7210 of 40 or more.

2. The foam body according to claim 1,
wherein a content of the vinyl aromatic monomer unit in the hydrogenated copolymer block (b) is 15% by mass or more and 79% by mass or less.

3. The foam body according to claim 1,
wherein the hydrogenated block copolymer (I) comprises at least one polymer block (a) principally containing a vinyl aromatic monomer unit, and
the content of the polymer block (a) principally containing a vinyl aromatic monomer unit in the hydrogenated block copolymer (I) is 15% by mass or more and 35% by mass or less.

4. The foam body according to claim 1,
wherein the hydrogenated block copolymer composition has a value of 15 seconds hardness measured with a type A durometer in accordance with JIS K6253 of 30 or more and 75 or less.

5. The foam body according to claim 1,
wherein the hydrogenated block copolymer composition has an MFR value measured under conditions of a temperature of 230° C. and a load of 2.16 kg in accordance with JIS K7210 of 100 or more and 1,000 or less.

6. The foam body according to claim 1,
wherein the non-foam skin layer has a thickness of 10 μm to 500 μm.

7. The foam body according to claim 1,
wherein the foam core layer has a thickness of 1,000 μm to 20,000 μm.

8. The foam body according to claim 1,
wherein the olefin-based resin (II) comprises at least one polypropylene-based resin.

9. The foam body according to claim 1, wherein the foaming ratio is 1.5-fold or more.

10. The foam body according to claim 1,
wherein the foam body is for use in a vehicle component selected from the group consisting of a side mall, a grommet, a shift knob, a weather strip, a window frame and a sealing material thereof, a dashboard, an assist grip, a steering wheel, a shift lever, a console, an arm rest, a head rest, and a door panel.

11. A method for producing the foam body according to claim 1, the method comprising:
a step of adding a foaming agent to the hydrogenated block copolymer composition, and injecting the resultant to fill a cavity, which is formed in a mold of an injection molding machine, and has a space volume adjustable with a movable core; and
a step of increasing the space volume of the cavity with the movable core to perform foam molding.

12. A laminate comprising:
a layer containing the foam body according to claim 1; and
a layer containing a base resin.

13. The laminate according to claim 12,
wherein the layer containing the base resin and the layer containing the foam body are in direct contact with each other without an adhesive layer therebetween.
